(19) United States
(12) Patent Application Publication
(10) Pub. No.: US 2020/0312279 A1
(43) Pub. Date: Oct. 1, 2020

(54) INTERACTIVE KITCHEN DISPLAY

(71) Applicant: GHSP, Inc., Grand Haven, MI (US)

(72) Inventors: Ian Sage, Holland, MI (US); Cort C. Corwin, Grand Haven, MI (US); Esai Umenei, Grand Rapids, MI (US); Josiah Bonewell, Grand Rapids, MI (US); David W. Baarman, Fennville, MI (US); Richard W. Harris, Kentwood, MI (US); Andrew Foley, Holland, MI (US)

(21) Appl. No.: 16/832,706

(22) Filed: Mar. 27, 2020

Related U.S. Application Data
(60) Provisional application No. 62/905,778, filed on Sep. 25, 2019.
(60) Provisional application No. 62/825,494, filed on Mar. 28, 2019.

(51) Int. Cl. G09G 5/14; G09G 5/38; G06F 3/044; G09G 3/32; G06F 3/01

(52) U.S. Cl. CPC G09G 5/14; G09G 5/38; G06F 3/044; G09G 3/32; F21S 8/03; G09G 2354/00; G09G 2370/06; G09G 2320/0693; G06F 3/011

(57) ABSTRACT

A system provides an elongated display that has a touchscreen with a multi-user interactive display area that is accessible simultaneously by at least two users. A sensor may monitor users at or near the interactive display area of the touchscreen, such as to transmit a sensor signal that identifies the presence of a user, which may be used to determine a location of the user relative to the elongated display. A characteristic of the user may also be identified with a sensor, where the characteristic may correspond with a user profile. The elongated display may display an image at a section of the interactive display area near the location of the user, where the image corresponds with a preselected setting of the user profile.

### CROSS-REFEERENCE TO RELATED APPLICATIONS

This application claims benefit and priority under 35 U.S.C. § 119(e) of U.S. Provisional Application Ser. No. 62/825,494, filed Mar. 28, 2019, and U.S. Provisional Application Ser. No. 62/905,778, filed Sep. 25, 2019, the contents of which are hereby incorporated herein by reference in their entireties.

### TECHNICAL FIELD

This disclosure relates to an interactive kitchen display.

### BACKGROUND

Over the years, one's home has continually embraced technology. From wired connections, such as the telephone, and the age of appliances to wireless connections and smart devices, the home is often ground zero to modern technology. As smart devices and the internet of things (IOT) world continues expanding, devices are increasing their connectivity to each other, remote servers, or the internet generally. With increased interconnectivity, home environments have begun to transition towards an ambient environment that adapts to people or to objects within the ambient environment. To facilitate such a transition, local ecosystems in the home that have previously lacked connectivity or connectivity management are beginning to leverage various sensors and the intercommunication of sensor data.

### SUMMARY

One aspect of the disclosure provides a system for an interactive kitchen display. The system includes an elongated display having a touchscreen that provides a multi-user interactive display area that is accessible simultaneously by at least two users. In some examples, the elongated display is configured to be disposed at a wall, such as a backsplash area where the interactive display area may span horizontally along a countertop and extend to upper cabinets to provide a seamless backsplash surface. The system also includes a sensor having a sensor field configured to capture users at or near the interactive display area of the touchscreen. The system further includes a controller. The controller is configured to receive a sensor signal from the sensor monitoring of the sensor field and determine a location of a first user relative to the elongated display based on the received sensor signal. The controller is also configured to identify a characteristic of the first user based on the received sensor signal and transmit an initiation communication to the elongated display to display a first image at a section of the interactive display area near the location of the first user. The characteristic corresponds with a user profile and the first image corresponds with a preselected setting of the user profile. In some examples, the first image is a control interface.

Implementations of the disclosure may include one or more of the following optional features. In some implementations, the controller is further configured to receive a gesture communication from the touchscreen in response to a gesture by the first user at the interactive display area and transmit a responsive communication to the elongated display to display a second image that confirms the gesture provided by the first user. Optionally, the controller may be configured to determine a second location of a second user at or near the interactive display area, while the first user is also located at or near the interactive display area, and identify a characteristic of the second user based on the sensor signal. Here, the controller may be configured to transmit an initiation communication to the elongated display to display a second image at a second section of the interactive display area near the location of the second user.

In some configurations, the sensor is configured to capture an object obstructing the interactive display area. In this configuration, the sensor is also configured to identify the object based on the sensor signal and display a control interface at a section of the elongated display that does not interfere with the identified object. The elongated display may include a plurality of display devices arranged side-by-side and a capacitive touch screen disposed over at least a portion of the plurality of display devices to define the interactive display area. The sensor may include at least one of a camera, a thermal imager, a microphone, an occupancy sensor, or a wireless receiver. The preselected setting of the user profile may include an arrangement of a control interface configured to operate at least one of an oven, a refrigerator, or a thermostat.

Another aspect of the disclosure provides an interactive display assembly. The interactive display assembly includes a plurality of display devices arranged side-by-side in a horizontal configuration to define an elongated continuous display area that is configured to be disposed at a wall surface. The interactive display assembly also includes a touchscreen overlaying at least a portion of the elongated continuous display area to define an interactive display area and a controller. The controller is configured to receive a first communication from the touchscreen in response to a touch event at the interactive display area on the touchscreen. The controller is also configured to transmit a second communication to at least one of the plurality of display devices to display an image at an underlying location of the touch event.

This aspect may include one or more of the following optional features. In some examples, the plurality of display devices includes at least two LED display panels. The touchscreen may be disposed over at least two display panels of the plurality of display devices. The touchscreen may include a capacitive touch panel.

In some implementations, the interactive display assembly includes a support base attached to an edge of the touchscreen, the touchscreen is configured to pivot about the support base away from the plurality of display devices and the wall surface. Here, the support base may include a channel that receives and supports a lower edge portion of the plurality of display devices. The lower edge portion of the plurality of display devices that is disposed in the channel may not be part of the interactive display area. The controller may be configured to determine the interactive display area with a calibration routine. The support base may be configured to be disposed between the wall surface and a countertop of a cabinet and may have a thickness that is substantially equal to a depth of the plurality of display devices. A power strip may be attached along an upper edge of the touchscreen, the power strip having at least one outlet that is configured to receive an accessory plug.

In some configurations, the interactive display assembly includes a sensor having a sensor field configured to encompass an area near the touchscreen. In this configuration, the sensor is configured to identify a user near a section of the elongated continuous display area. Here, the controller may be configured to cause the plurality of display devices to display the image at the section of the elongated continuous display area identified nearest the user and the image may include a control interface. Optionally, the sensor may include at least one of a camera, a thermal imager, a microphone, an occupancy sensor, or a wireless receiver.

In some examples, the image includes a control interface configured to operate at least one of an oven, a refrigerator, or a thermostat. The interactive display assembly may include a light assembly attached along an upper edge of the touchscreen, the light assembly having a light element that is configured to direct light onto a countertop surface.

These and other objects, advantages, purposes, and features of the present disclosure will become apparent upon review of the following specification in conjunction with the drawings.

### DESCRIPTION OF THE DRAWINGS

FIG. 1A is a schematic view of an example home environment with smart devices.

FIG. 1B is a schematic view of an example kitchen as a local ecosystem within the home environment that includes an interactive display.

FIG. 1C is a perspective view of an example kitchen as a local ecosystem within the home environment that includes an interactive display.

FIG. 2A is a perspective view of an example interactive display.

FIG. 2B is a cross sectional view of an example display for an interactive display.

FIG. 2C is a cross sectional view of an example display for an interactive display.

FIG. 2D is a perspective view of the example interactive display shown in FIG. 1C.

FIG. 2E is an enlarged view of example display content for the interactive display of FIG. 1C.

FIG. 2F-2I are schematic diagrams of example interactive displays.

FIG. 2J is a flow chart diagram for user identification and interaction with an interactive display.

FIG. 2K is a schematic view of an example calibration routine for an interactive display.

FIGS. 3A-3C are perspective views of example interactive displays.

FIGS. 4A and 4B are perspective views of example kitchens using an interactive display.

FIGS. 4C-4E are schematic views of example kitchens using an interactive display.

FIG. 5 is an example arrangement of operations to activate an interactive display.

FIG. 6 is an example arrangement of operations to activate an interactive display.

FIG. 7 is a schematic view of an example computing device.

Like reference symbols in the various drawings indicate like elements.

### DETAILED DESCRIPTION

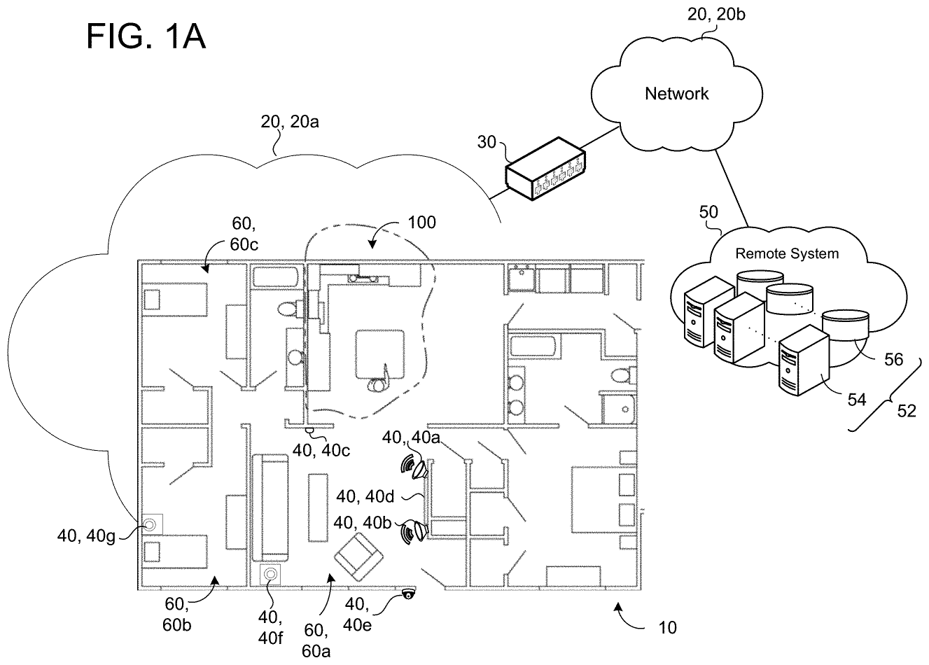

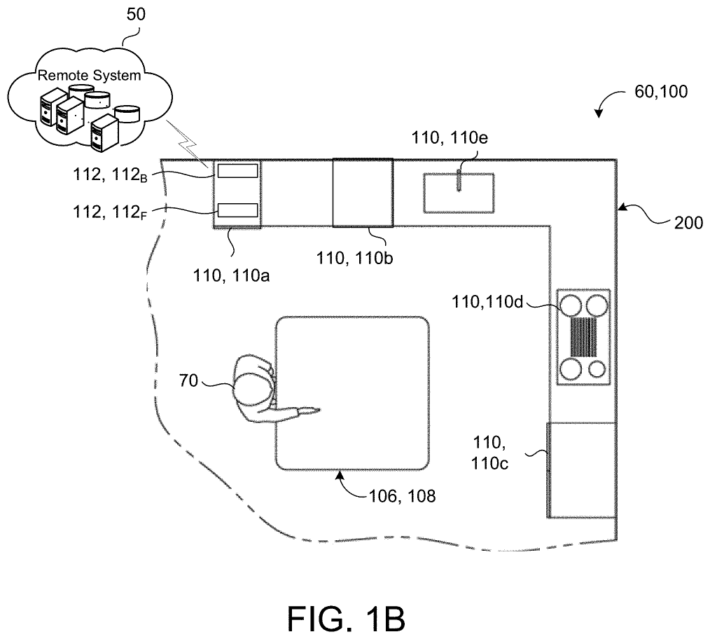

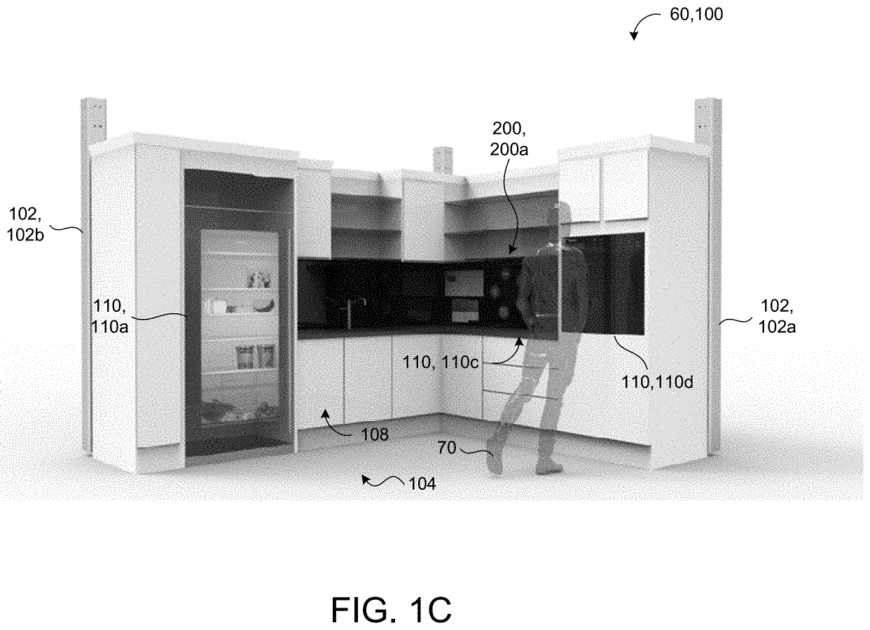

FIG. 1A is an example of a home environment 10. The home environment 10 is a spatial environment used as a permanent or a semi-permanent residence for an individual or a family. As a spatial environment, a home refers to an indoor area internal to a structure of the home as well as an outdoor area, such as a patio and/or a yard, external to the structure of the home. A home environment 10 may include one or more networks 20 (e.g., a mesh network or a local area network (LAN)) connected by one or more network devices 30 (e.g., router(s)). A network device 30 generally functions to connect other devices 40, 40a-n, such as computers, mobile phones, tablets, internet of things (IoT) devices, smart devices, etc., to a network 20. For example, FIG. 1A depicts smart speakers 40, 40a-b, a smart thermostat 40, 40c, a smart television 40, 40d, a smart doorbell 40, 40e, and lamps 40, 40g using smart lighting. As a connective hub for devices 40, a network device 30 (e.g., generally in the home environment 10 even though shown outside the home for understanding) also serves as a gateway (e.g., a residential gateway) providing a bridge between a LAN network 20, 20a and a wide area network (WAN) 20, 20b, such as the internet.

The network device 30 is configured to manage devices 40 and to forward packets of data (e.g., among the LAN network 20) in order to communicate between these devices 40 and/or to remote devices 50 (e.g., remote servers external to the LAN network 20). Here, remote devices 50 may be an entire remote system (e.g., a cloud environment) with, for example, remote computing devices and/or remote resources 52 (e.g., remote data processing hardware 54 and/or remote memory hardware 56). In some examples, devices 40 of the LAN network 20 within the home environment 10 communicate with remote systems across a network 20 (e.g., a WAN network 20) by a network device's connection to equipment of an internet service provider (ISP). By having a means of communication between a remote system (e.g., remote servers) and a local system (e.g., configured by a network device 30), devices 40 may utilize remote computing resources 52 for various storage or processing needs separately, or in combination with, local computing resources (e.g., local data processing hardware or local memory hardware).

In some implementations, devices 40, whose network connectivity may be managed by a network device 30, are traditional connected devices (i.e., standard computing devices). For instance, devices 40 refer to computers or mobile devices (e.g., laptops, tablets, mobile phones, wearables, etc.). Yet additionally or alternatively, these devices 40 may be non-traditional connected devices, such as everyday objects, that have been configured to connect to a network 20 and/or to transmit data. These non-traditional connected devices may refer to internet of things (IoT) devices or other home automation devices (e.g., speakers, thermostats, security systems, doorbells, sprinklers, heating and cooling systems, locks, etc.) Some refer to these non-traditional connected devices as traditionally dumb devices that have become “smart” devices based on embedded hardware and/or software that allows, for example, remote control, monitoring, and/or communication. Thus, the term “smart” refers to a non-traditional connected device that has been outfit with communication capabilities. In some configurations, smart devices 40 actively and/or passively gather data via sensors and communicate the data to other devices 30, 40, 50 within a network 20 or external to a network 20. Often these devices 40 are wireless devices, although some may include one or more connection ports for a wired connection. In some implementations, devices 40 communicate not only with a network device 30, but also amongst each other.

Depending on a configuration of the home environment 10, the home environment 10 may be subdivided into local ecosystems (e.g., one or more rooms) 60. For example, FIG. 1A depicts three local ecosystems 60, 60a-c corresponding to a living room 60a, a first bedroom 60b, and a second bedroom 60c. Each local ecosystem 60 refers to a three dimensional space with devices 40 configured to communicate with other device(s) 40, a node of a network device 30, or directly to the network device 30. In other words, connectable devices 30, 40 within a given space (e.g., dedicated to a particular space) form a local ecosystem 60. To illustrate, a local ecosystem 50 may include devices 40 such as smart lighting, smart displays (e.g., smart televisions or monitors), smart appliances, smart speakers systems, smart blinds, smart thermostats, smart ventilation, etc. Here, the local ecosystem 60 may be integrated with a larger home automation system communicating across more than one local ecosystem 60 (e.g., a smart home or smart hub) or be independent of other local ecosystems 60 within the home environment 10.

Referring to FIGS. 1B and 1C, the local ecosystem 60 is a kitchen 100. The kitchen 100 generally refers to a room within the home environment 10 that includes a means for cooking (e.g., appliances that are cooking devices) and a means for food storage (e.g., refrigerators, pantries, or cabinetry). Here, the kitchen 100 may have several different types of devices 40 in the form of appliances 110, 110a-n. Some examples of appliances 110 include refrigerators 110, 110a, dishwashers 110, 110b, ovens 110, 110c, stove/vent hoods 110, 110d (i.e., ventilation systems), coffee makers, microwaves, thermometers, cooking devices (e.g., slow cookers, pressure cookers, or sous vide devices), faucets 110, 110e, etc. In some configurations, these appliances 110 communicate with other devices 40 located within the kitchen 100 or elsewhere in the home environment 10 (e.g., home automation hubs, automated blinds, lighting, mobile devices, etc.). As types of devices 40, these appliances 110 may have some or all of their traditional functionality remotely controllable and/or communicable. For example, in some instances, a stove may be configured to remotely turn off or on as well as communicate temperature of heating elements while, in other instances, the stove may communicate temperature once on, but not permit remote control to enable or to disable heating elements (i.e., to turn off and on).

In some examples, one or more of the appliances 110 includes an interface 112 as a means of communication between the appliance 110 and other devices 30, 40, 50. In these examples, the interface 112 may be an application programming interface (API). In some implementations, an appliance 110 includes a frontend API 112F, a backend API 112B, or some combination of both. Here, a frontend API 112F refers to an API that is external facing such that a user 70 within the local ecosystem 50 (or the home environment 10 more generally) may interact with the functionality of the appliance 110. For example, an appliance 110 includes its own display allowing a user 70 to interact with the controls of the appliance 110 via the frontend API 112F. With a frontend API 112F, a user 70 may be able to configure communication with other devices 40 within the home environment 10. For example, a user 70 configures an appliance 110 to recognize a mobile device 40 of the user 70.

In contrast, an appliance 110 may include a backend API 112B that is not external facing to the user 60. Instead, an appliance maker (e.g., designer or manufacturer) may control connections to and from (e.g., by authorization) a given appliance 110. In some configurations, the backend API 112B is not local to a location of the appliance 110 associated with the backend API 112B. In some examples, with a backend API 112B, only particular devices 40 (e.g., authorized devices 40) connect to the backend API 112B. For example, an appliance maker authorizes some types of devices 40 to communicate with the appliance 110, but not others. To illustrate, an appliance maker may allow other types of appliances 110 in the kitchen 100 to communicate with the backend API 112B of the appliance 110. In some examples, an appliance maker produces several different types of appliances 110 and only allows communication between these appliances 110 through the backend API 112B. For instance, this approach may allow an appliance maker to preprogram communication at the backend API 112B between authorized appliances 110.

In some implementations, either API 112F, 112B may be configured to communicate with a remote system (e.g., a remote server). In some examples, appliance makers, or a party in contract with an appliance maker, operates a proprietary server to facilitate communication with a particular appliance 110 or a group of appliances 110. In other words, a server may manage data transfer and/or connectivity for an appliance 110 and/or between appliances 110. With a server, an administrator of the server may perform functions such as controlling communication, connectivity, authentication, or access to data associated with an appliance 110.

Some appliance makers (e.g., designers and/or manufacturers) may prefer to maintain aspects of control for particular appliances 110 and/or features of appliances 110. This may be especially true in the kitchen 100 due to safety risks. Here, appliance makers are often concerned that remote control capability for appliances 110 may increase the risk of home fires or home fire-related injuries especially when cooking fires in the kitchen 100 are generally a significant cause of home fires and home fire-related injuries already. For instance, statistically speaking most home fires start in the kitchen. In a home environment 10, particularly with distractions, it is not uncommon for these distractions to draw someone's attention away from a cooking area leaving it unattended. Thus, there is a concern that remote control capability of appliances 110, particularly appliances 110 related to cooking, would increase the frequency of an unintended cooking area. To illustrate, a user 60 may turn on the oven or the stove remotely on his or her way home from the grocery store, but then realize that he/she forgot a much needed grocery and head back to the grocery store. Here, the oven or the stove will be left unattended for a longer period of time than originally anticipated by the user 70; resulting in the convenience of remote control potentially jeopardizing the safety of the home environment 10.

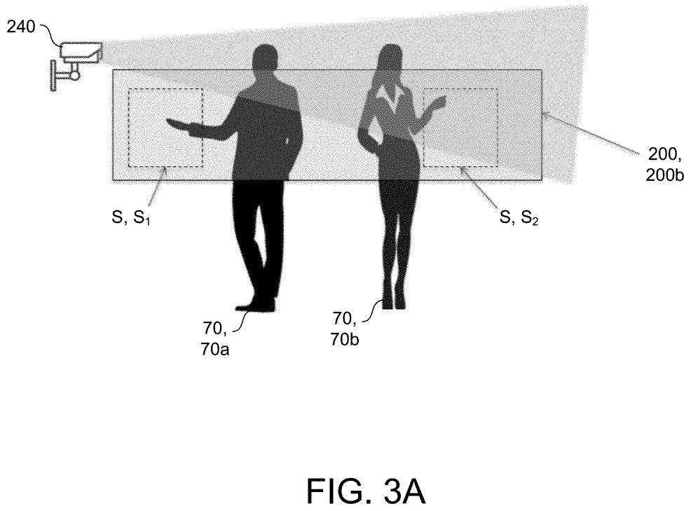

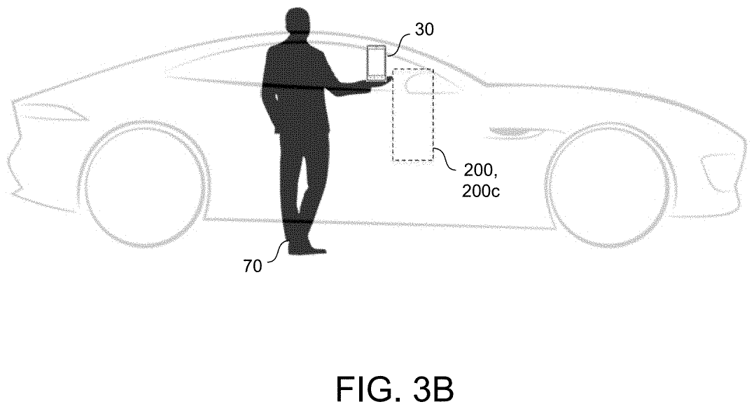

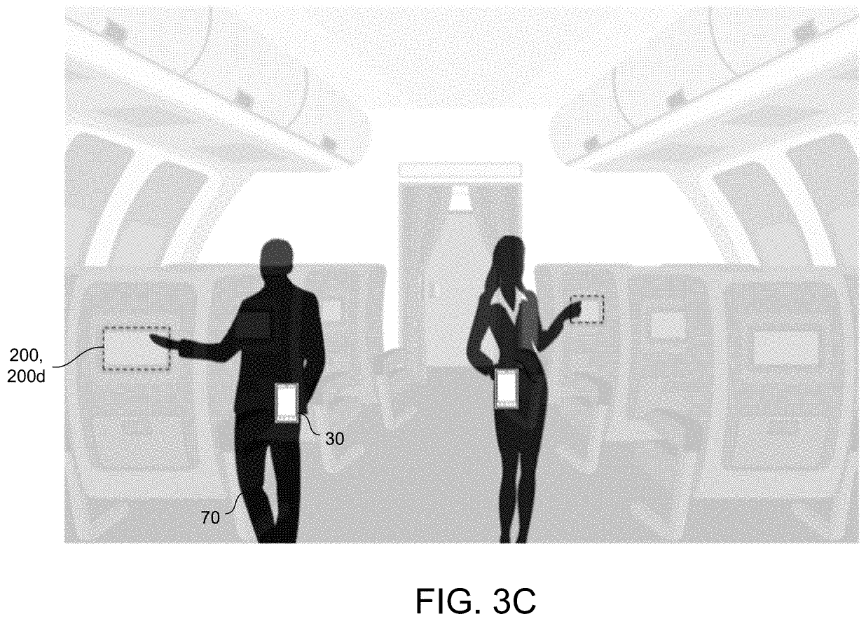

Due to such risk, appliance makers, or the kitchen industry more generally, have been hesitant to allow remote connections and/or remote control from other devices 40. For instance, smart homes and/or home automation system seem to rarely control and/or manage some appliances 110, let alone all of the appliances 110 within the kitchen 100. To overcome concerns with remote control safety and yet still provide a smart hub for appliances 110, the kitchen 100 includes an interactive display 200. Although the interactive display 200 may be configured with the interactive functionality described herein in many different forms (e.g., as shown in FIGS. 3A-3C), the interactive display 200 is generally described as an interactive backsplash 200, 200a (also referred to as a smart backsplash). Generally speaking, a backsplash refers to a panel behind a countertop, a sink, or a stove that protects a wall (e.g., shown as vertical wall 102) within a room (e.g., the kitchen 100) from splashes or damage. As protection for a wall, often the backsplash 200a is a vertical structure such that it is perpendicular with a floor 104 of the room (e.g., the kitchen 100) or a horizontal surface 106, such as a countertop, that is offset from the floor 104 of the room by one or more cabinets 108. In some kitchens, the backsplash 200a extends along more than one wall (e.g., wall 102, 102a) to adjacent walls (e.g., adjacent wall 102, 120b). For instance, it is not uncommon for kitchens to include tiled backsplashes that extend from behind a sink on a first wall 102b to behind a stove on a second wall 102a (e.g., adjacent to the first wall). This may be for aesthetic purposes to maintain clean lines or a pattern of lines while still protecting structural components of the room (e.g., the walls).

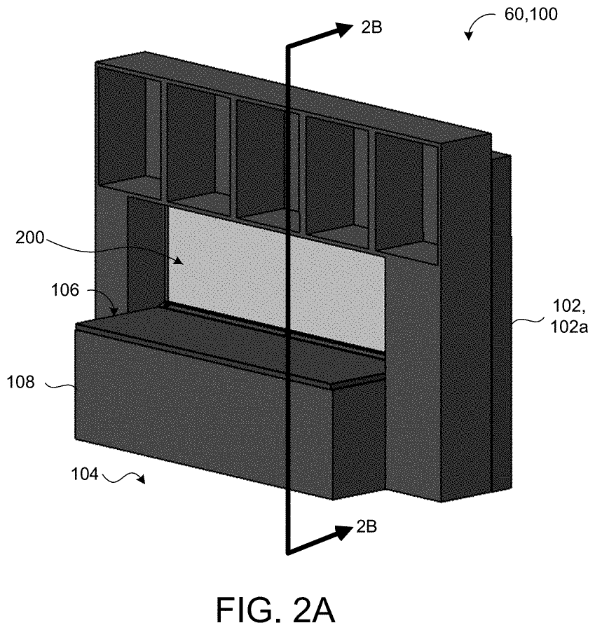

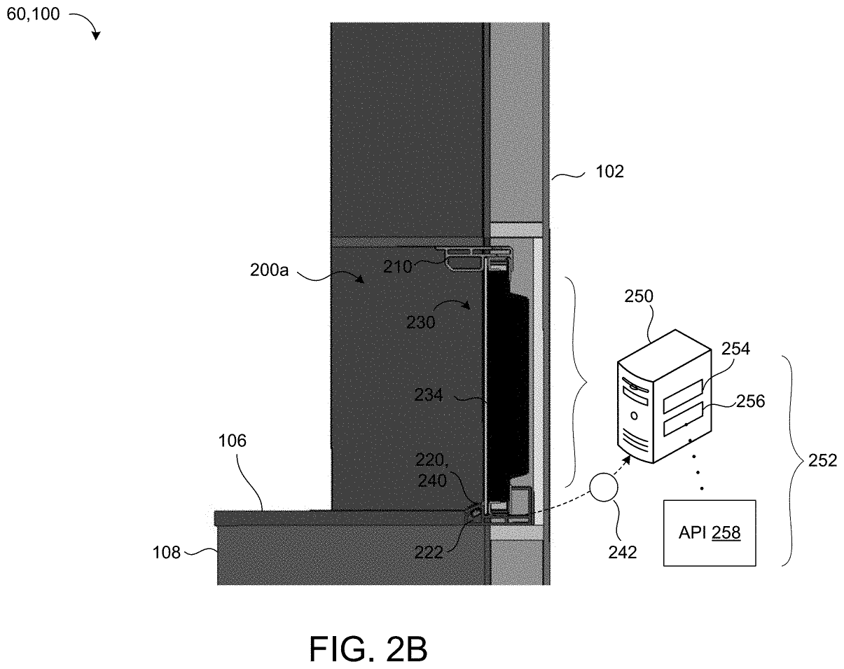

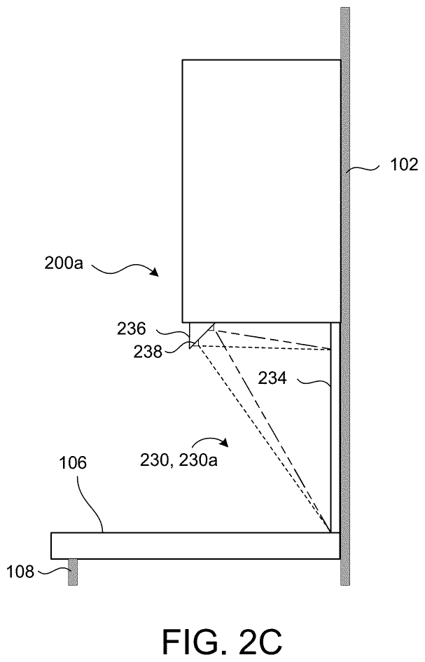

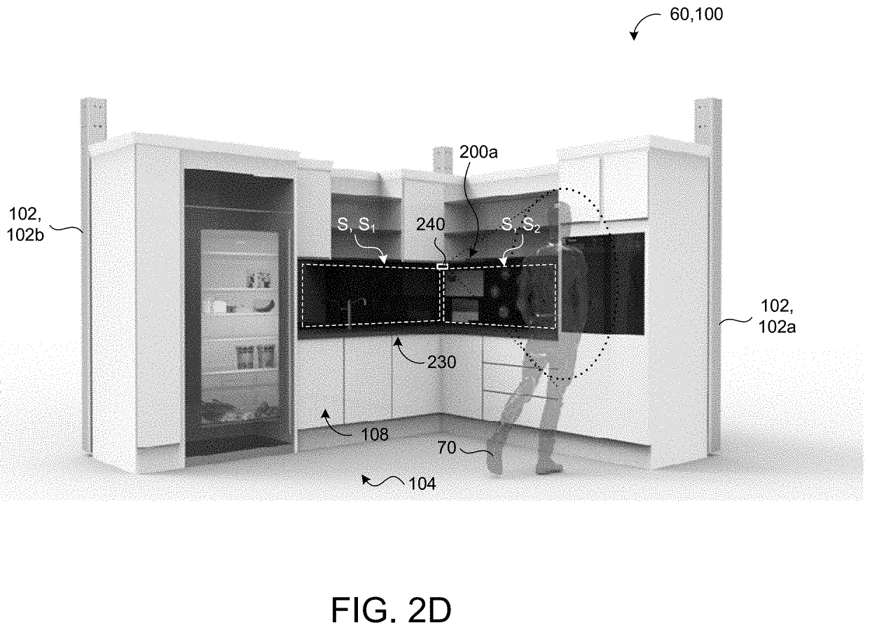

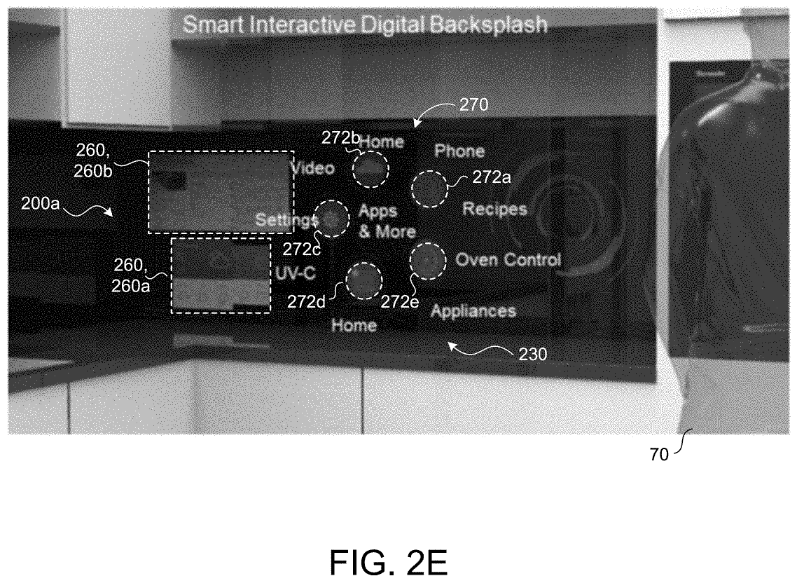

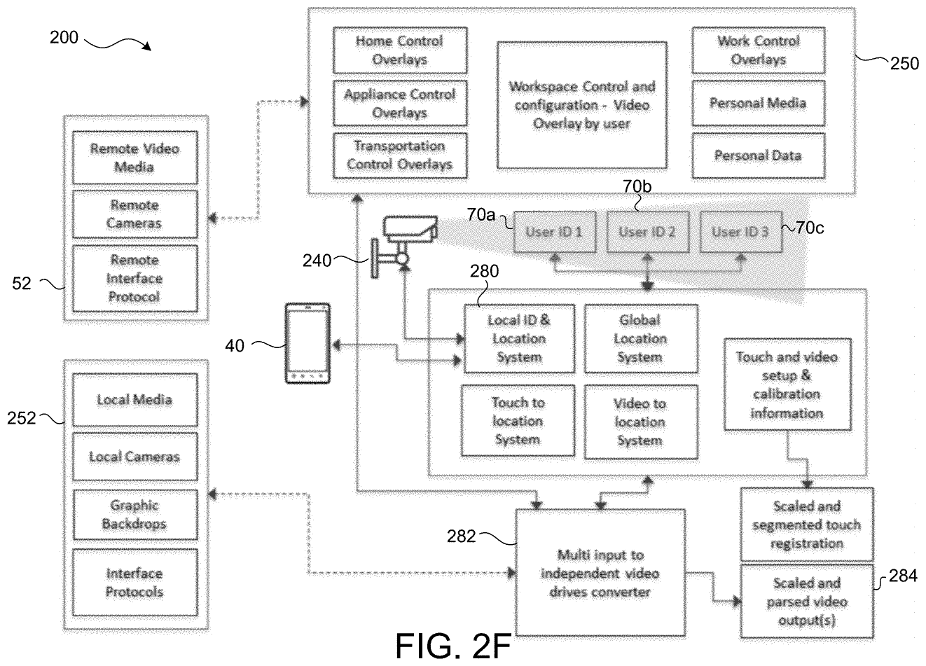

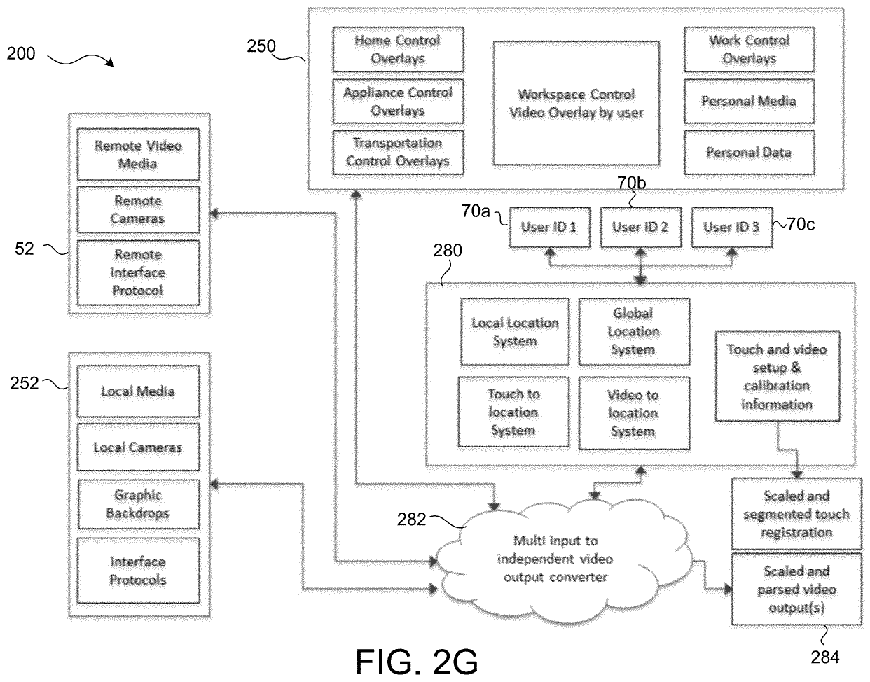

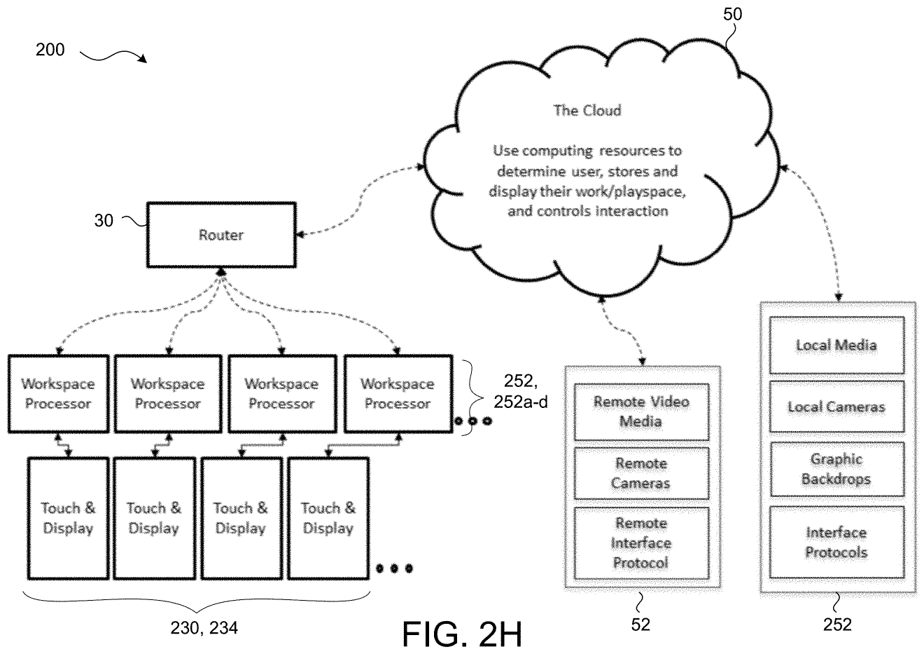

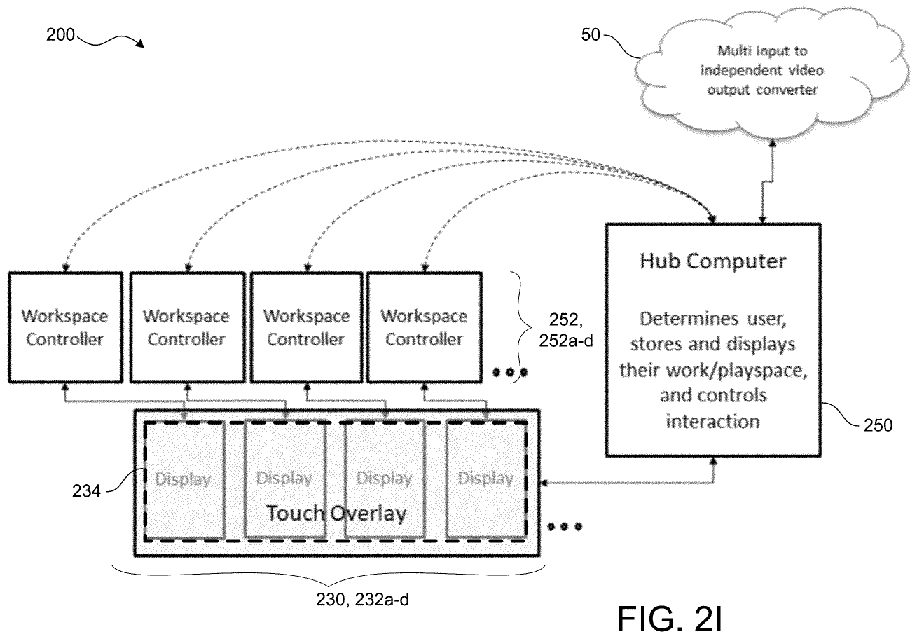

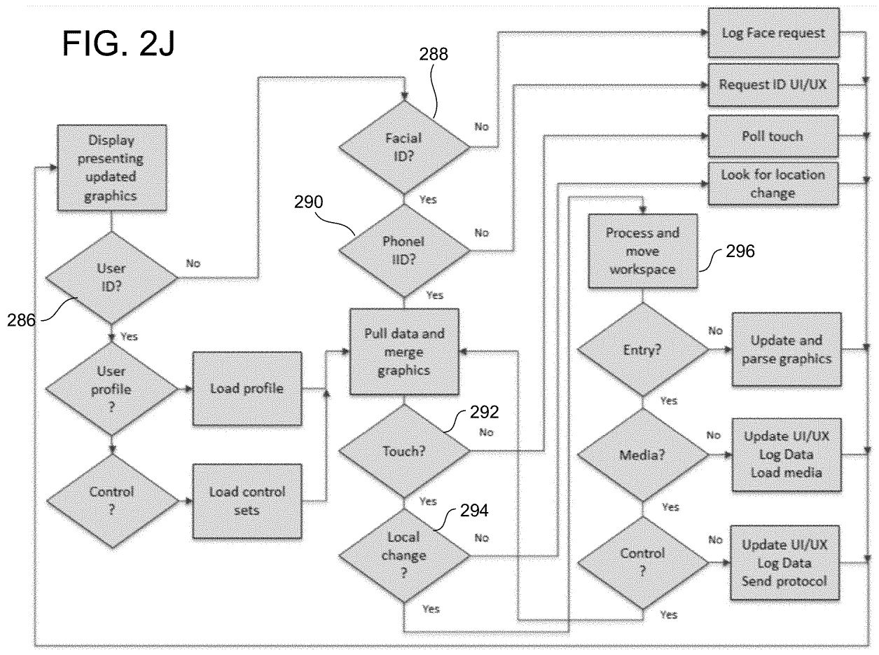

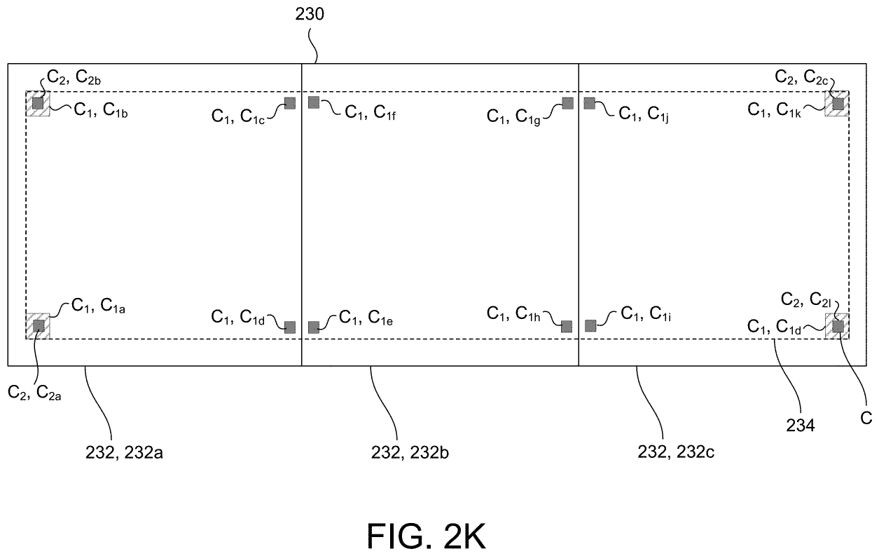

Referring to FIGS. 2A and 2B, in some examples, the backsplash 200a includes an upper mounting bracket 210 and a lower mounting bracket 220. Each bracket 210, 220 is configured to secure one or more interactive displays 230. Lower bracket 220 includes a lower channel 222. In some examples, the lower channel 222 includes one or more electrical outlets (e.g., to provide electrical power at the backsplash 200a for powering small appliances or other devices that may plug into such an outlet). In some implementations, the lower bracket 220 is angled with respect to the vertical wall and a horizontal surface, such as the countertop. For example, the lower bracket 220 is mounted at a 45 degree angle with respect to the backsplash 200a and the countertop. The upper bracket 210 may include accessories, such as speakers, lights (e.g., ultra-violet lights), LEDs, etc. A lower edge portion of one of the displays 230 may be received by the lower channel 222 (e.g., the bracket 220 of the lower channel 222). In some implementations, the attachment of the display 230 at the bracket 220 enables the display 230 to pivot about the lower channel 222 (e.g., away from the wall 102). For instance, the pivoting of the display 230 provides serviceable access to the display 230 or other components of the backsplash 200a. The channel 222 may be formed, such as by extrusion of the lower bracket 220, to have an upward facing channel that receives and supports the lower edge portion of the display 230. The lower edge portion of the display 230 that is disposed in the bracket 220 or channel 222 may not be accessible to interactive input (e.g., touch input), such that it is not be part of the interactive display area. In some configurations, the lower bracket 220 is configured to be disposed generally between a surface of the wall 102 and a back edge of the countertop 106 of a lower cabinet 108. For example, as shown in FIG. 2B, the wall 102 has a framed construction with studs that are covered with a wall paneling, such drywall or plaster and lath, where the brackets 210, 220 are recessed into the wall 102 between the studs to position the front surface of the display 230 at or near outer surface of the wall 102. Such recessed mounting of the brackets 210, 220 and display 230 generally does not occupy or otherwise restrict the useable horizontal surface of the countertop. Each bracket 210, 220 may have a thickness that is greater than or substantially equal to the depth of the display 230. Alternatively, some implementations mount the brackets and display at the outer surface of the wall.

In some examples, the one or more electrical outlets may form a power strip along an edge of the display 230 (e.g., an upper or lower edge). The power strip includes has at least one outlet that is configured to receive an accessory power plug, such as a conventional NEMA socket or USB socket or the like. To avoid routing wires for powering the power strip in visible or otherwise inconvenient locations, such as between the display 230 and the surface of the wall 102, the power strip may have a cable that extends into an enclosed area of a cabinet 108 above the display 230 (i.e., adjacent to the upper bracket 210). In some implementations, the power strip includes a latch or releasable fastener that attaches to the wall 102 or cabinet 108 to secure the backsplash 200a against a surface of the wall 102. A supplemental light may be incorporated with or attached to the power strip, such as to provide under cabinet lighting and/or UV light disinfection of the display panel and/or countertop work surface or items resting on the countertop.

The display 230 is a device (e.g., a monitor) that is configured to display multi-media in a display area associated with the display 230. The display 230 may be an LED display, a plasma display, a CRT display, or other types of display panels. In some examples, the display 230, as part of the backsplash 200a, has a height extending along the vertical wall perpendicular to the floor. In other examples, the brackets 210, 220 securing the display 230 configure the display 230 at an angle with respect to a surface of a vertical wall 102 behind the display 230. The display 230 may be one continuous screen 232 extending some horizontal width (i.e., an elongated display) along the wall or include a plurality of screens 232, 232a-n.

As a plurality of screens 232, the screens 232 may be in communication with each other to allow content displayed on a first screen 232 to move to another screen 232 (e.g., without disappearing). To coordinate multiple screens 232, in some implementations, the display 230 functions in an extend monitor mode. In other words, no matter how many screens 232 are included in the display 230, each screen becomes an extension of its neighboring screen. In some examples, an operating system (OS) internal or external to the display 230 enables the extend monitor mode. For instance, the display 230 functions as a peripheral to an external computing device (e.g., computing device 250).

In some implementations, each screen 232 of the display 230 is configured to communicate with a router (e.g., a network device 30). Here, the router or network device 30 may act as a server that manages interaction between screens 232 of the display 230. With a router acting as a server, each screen 232 of the display 230 may undergo an initialization process that communicates to the router a location and an orientation of the screen 232. With this information, the router is able to fluidly handover information (e.g., content) shown on the display 230 between screens 232. In some examples, the router assigns an internet protocol (IP) address to each screen 232 to communicate between the screens 232 (e.g., after initialization). Either technique to manage screens 232 of the device 230 may minimize latency and maintain fluid movement of windows between screens 232.

Even though the display 230 may include multiple screens 232, the external appearance of the display 230 may appear continuous. To achieve visual continuity, the display 230 includes an overlay 234 (e.g., a glass overlay 234 or other transparent or semi-transparent overlay) covering the one or more screens 232 of the display 230. Here, the overlay 234 may be the outermost surface (i.e., external surface) seen by the user 70. As such, in some examples, a substrate of the overlay 234 includes a clear or an opaque sheet material to provide a substantially uninterrupted flat outer surface. In some implementations, the overlay 234 may be constructed to provide a seamless backsplash surface that is capable of easily being wiped clean of liquids, sauces, or other materials that may splash onto or otherwise come into contact with the touchscreen surface from typical activities performed at the working surface of the countertop, cooktop, or sink or the like. Like other surfaces within a kitchen 100, the backsplash 200a (e.g., the overlay 234 and/or the display 230) may be constructed (e.g., as a solid or blended uniform panel) such that it is capable of being easily sanitized, such as with UV light or a physical cleaning process.

In some examples, besides visual continuity, the overlay 234 enables the display to be interactive by touch (i.e., a touchscreen). For example, the overlay 234 includes a touch-sensor circuit that enables touch sensitive capability. Some examples of touch-sensor circuits that may be integrated into the overlay 234 include 5-wire resistive circuits, capacitive (e.g., surface capacitive or projected capacitive) circuits, surface acoustic wave (SAW) circuits, or infrared touch circuits. In some configurations, the overlay 234 is a peripheral of the display 230 mounted on an exterior surface of the display 230 facing away from the vertical wall 102 (e.g., mounted and/or secured by the brackets 210, 220). For example, the overlay 234 connects to the display 230 by a universal serial bus (USB). The overlay 234 may be easily sized for a specific backsplash area, such as with a tailorable touchscreen panel or sheet that may have a proximal edge that connects to a data cord and a distal edge that may be trimmed to provide the desired panel length between the proximal and distal edges, such as a touchscreen sheet that allows cutting at 0.25″ increments.

In some configurations, the backsplash 200a may be installed by arranging the screens 232 of the display 230 side-by-side in a horizontal configuration at or on a surface of a wall 102 (e.g., defining an elongated display area). A touchscreen panel (i.e., overlay 234) may be disposed over a usable portion the screens 232 (such as to exclude portions of the display hidden behind an appliance or in a channel of the support base) to provide an interactive display area where the touchscreen panel 234 and the elongated display area of the screens 232 of the display 230 overlap.

Additionally or alternatively, FIG. 2C depicts the backsplash 200a may incorporate a projected display 230, 230a. A projected display 230 may be an alternative to non-projection based displays 230 or used in conjunction with other non-projection displays 230. The projected display 230a generally functions to project a display area on a portion of the backsplash 200a that enables user interaction (e.g., the overlay 234 that functions as a touchscreen portion of the backsplash 200a). The projection may occur as a front projected visual overlay or a rear projected visual overlay (e.g., projected from the rear of the backsplash 200a). In some examples, such as FIG. 2C, a backsplash 200a with a projected display 230a includes a projection module 236. The projection module 236 may include display hardware 238, such as a projector head that projects the display area on a surface of the vertical wall 102. For instance, as shown in FIG. 2C, a projector module 236 may be mounted near a surface of a backsplash wall 102, such as at an underside of an upper cabinet 108. In some implementations, the projection module 236 also includes sensors (e.g., described further below) or utilizes information received from sensors to integrate with its display capabilities. As described further below, the backsplash 200a with the projected display 230a may also include sensors 240 such that the display area formed by projection of the display 230a and sensor field may overlap on the wall 102. With an overlay 234 combined with the display area, the backsplash 200a is configured to both display a transparent projected image and to perform accurate gesture recognition at the surface of the backsplash 200a. In some examples, the display area and sensor field provided by the projector module 236 are directed against additional or alternative surfaces within the kitchen 60, such as countertops 106, cabinets 108, or walls 102.

As an elongated display 230, the display 230 may accommodate for multiple users of the display 230 simultaneously. For example, FIG. 2D depicts two sections S, S₁₋₂ (e.g., areas within the display 230) of the backsplash 200a outlined to illustrate how the section S₁ nearest the identified user 70 is used to display an image in response to a determination of the user's presence. The other section S₂ of a display area for the display 230 may also be used by the identified user 70, such as when the user 70 re-locates closer to the other section S₂, and/or it may be used by an additional user 70 that moves into an area near the open or available section S₂ of the display 230 for the backsplash 200a. Although, in FIG. 2D, the display 230 is shown with two sections S, in other examples, the display 230 may have additional sections S or may be subdivided into alternative section arrangements and configurations, such as multiple sections S along a single planar surface or vertically segmented sections S of the display 230 or other conceivable section segmentations.

As stated previously, the backsplash 200a also includes one or more sensors 240. Each sensor 240 of the backsplash 200a may be disposed on, integrated with, attached to (e.g., via a wired connection), or communicating with (e.g., via a wireless connection) the display 230. For example, the upper bracket 210 and/or the lower bracket 220 houses the sensor 240. In some examples, a sensor 240 of the backsplash 200a connects to the backsplash 200a as a USB peripheral device. In some implementations, the backsplash 200a includes multiple sensors 240 at different locations relative to the display. The sensor(s) 240 are generally configured to monitor activity within their sensing field. For examples, the user's location may be dynamically monitored by one or more sensors 240 to update the displayed location of the image (e.g., media content displayed on the backsplash 200a). Here, the media content location may be modified or repositioned (e.g., to maintain accessibility/visibility to the user 70) by the user 70 or by functionality of the backsplash 200a (e.g., data gathered by the sensors 240). The location of the user 70 relative to the backsplash 200a may be determined various ways, which may depend upon on the type of sensors 240 integrated into the backsplash system.

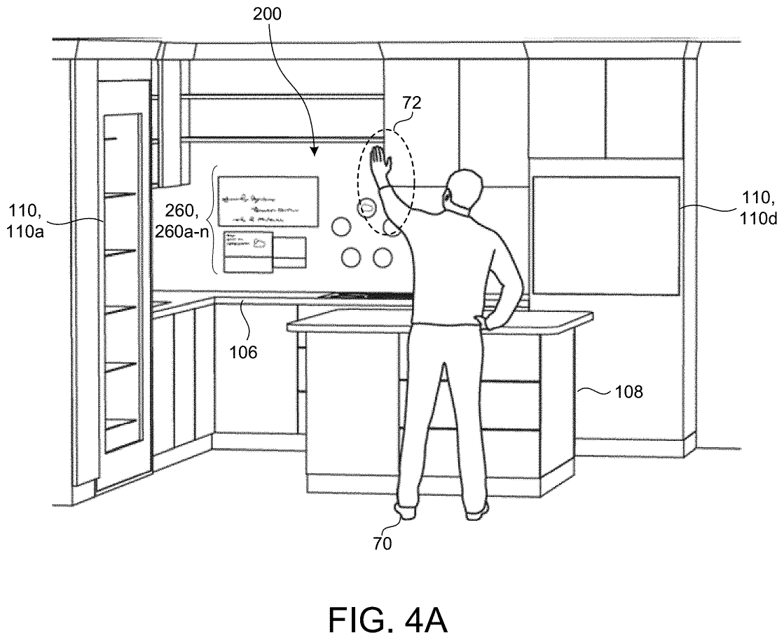

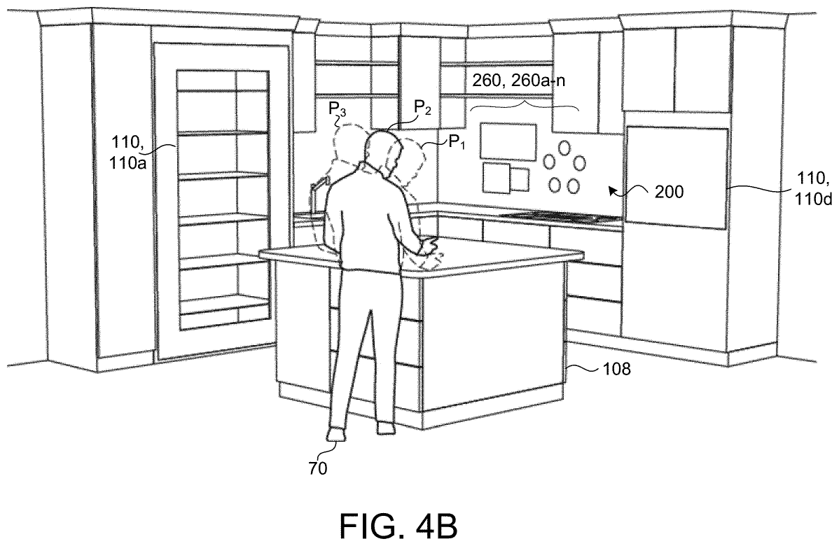

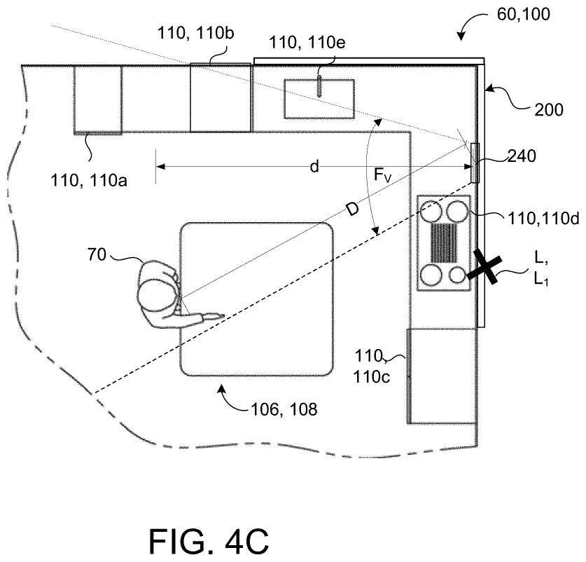

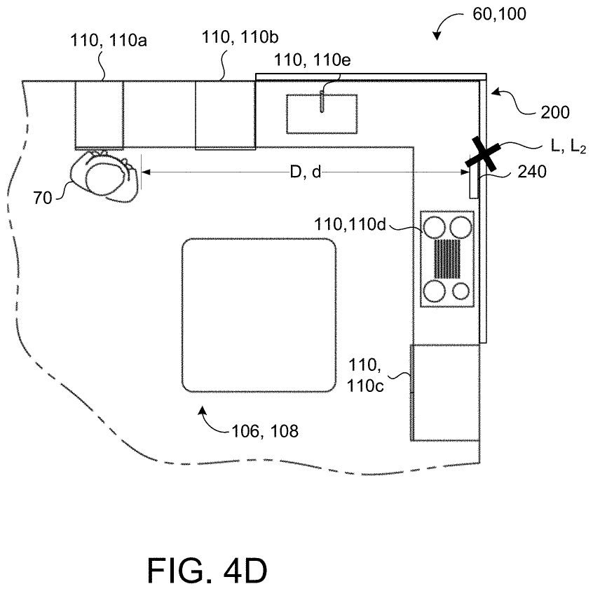

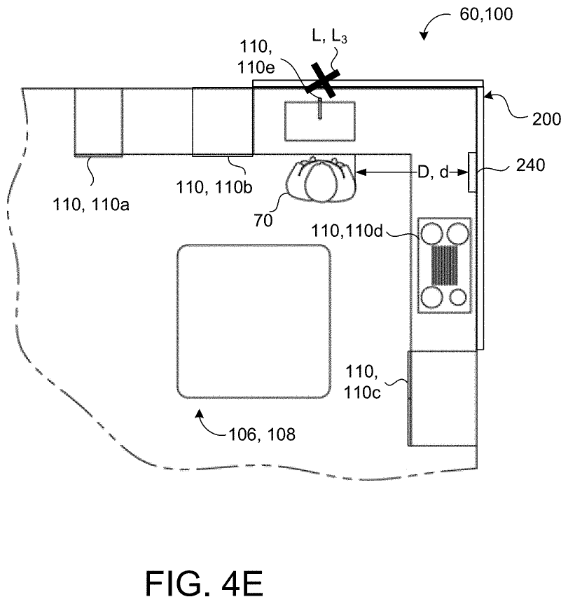

The type of sensor 240 of the backsplash 200a may vary depending on a design of the backsplash 200a and/or different applications. Generally speaking, the sensor 240 is a vision/image sensor 240 (e.g., optical sensor) though other sensors may be utilized as well (e.g., inertial sensors, force sensors, kinematic sensors, etc.). Some examples of a vision sensor 240 include a camera such as a stereo camera, a time-of-flight (TOF) camera, a scanning light-detection and ranging (LIDAR) sensor, a scanning laser-detection and ranging (LADAR) sensor, a depth-sensing infrared (IR) camera, thermal imaging camera, infrared sensor, or other types of depth cameras. Some types of image sensors include CCD image sensors or CMOS image sensors. In some configurations, the sensor(s) 240 includes multiple types of cameras (e.g., TOF and IR) to provide a wide range of sensing capabilities. In some examples, the sensor 240 has a corresponding field(s) of view Fv (e.g., shown in FIG. 4C) defining a sensing range or region corresponding to the sensor 240. In some implementations, the sensor 240 has a range of about three meters, such that it may predominantly sense objects (e.g., the user 70) within the kitchen 100 near the backsplash 200a.

In some examples, the sensor 240 includes additional features such as a means to rotate or to pivot such that the sensor 240 may, for example, change the field of view FV about one or more axis (e.g., an x-axis, a y-axis, or a z-axis in relation to a floor 104). Additionally or alternatively, the sensor 240 includes audio capturing capabilities such as a microphone or a microphone array. With audio capturing capabilities, the sensor 240 may allow the backsplash 200a to include the ability to interpret speech from the user 70 or other audio input (e.g., voice recognition, speech learning, speech parsing, speech modeling, etc.). For example, the sensor 240 receives a voice command from the user 70 and the backsplash 200a executes a display response (e.g., the display 230 moves a window, terminates a window, or generates a window). Audio sensors 240 (e.g., a microphone) may also be used to sense other environmental noises that may be used as a triggering event to operate features of the backsplash 200a that may be relevant or related to the sensed noise. For instance, if the sensor captured the noise of chopping on a cutting board, the backsplash 200a may be programmed to display an application on the display 230 that is the associated with recipes, grocery shopping, cooking, or a control interface of the cooktop, microwave, or oven or the like.

Moreover, a sensor 240 may include a wireless receiver that is capable of receiving radio waves, such as via Bluetooth or Wi-Fi signals generated by a wireless device carried by a user 70 (such as a devices 30, 40). The wireless receiver may, for example, then be used to determine the user location via the user's cell phone BTLE, WiFi and MAC address along with signal strength. It is also contemplated that the sensor 240 may include an occupancy sensor, such as an ultrasonic receiver or RFID receiver. The backsplash 200a may use one or more sensors 240 and various types of sensors 240 (e.g., as discussed above) to provide the desired user identification and location function, or otherwise monitor for the desired triggering event. The sensors 240 may repeatedly update or otherwise continuously operate to dynamically update the location of the identified user 70 or users 70. For instance, the content on a display 230 of the backsplash 200a can continuously be repositioned to provide access to the displayed content and improved workflow. The user's touch interactions with an overlay 234 (e.g., a touchscreen) may also confirm or provide the user's updated location relative to the display 230. This allows users 70 to continuously interact with desired displayed content along the display 230 and to make displayed content at such a device easily and conveniently viewable without the need to reposition a device (e.g., devices 30, 40) in communication with the backsplash 200a.

While the location or proximity distance of a user 70 present near the display 230 may be a factor in the determination of what image or data to display, how to present the image or data, and/or where to display the image or data on the display 230, the backsplash 200a may also or alternatively initiate the displayed content based on other factors, such as the user's identity or display preferences. Similar to location, the identity of the user 70 may be determined in various ways, which may depend upon the type of sensor 240 or sensors 240 implemented on the system. For example, the sensor 240 may be used to identify one or more characteristics of the user 70, such as the user's height, body shape, facial characteristic, thermal signature, voice, audible password or voice instruction, RFID tag, wireless device presence, or other conceivable characteristic identifiable by one or more of the sensors 240 utilized by the backsplash 200a. The identified characteristic may then be used by the backsplash 200a (e.g., the computing device 250) to match the present user 70 with a user profile for the backsplash 200a. The user profile of the backsplash 200a may provide the system with access to local or remotely stored user data, any preselected settings, applicable device access, or otherwise available information associated with the identified user.

Additionally or alternatively, in some examples, the backsplash 200a may adaptively initiate the displayed content based on behaviors, patterns, or changes to user behavior or patterns (e.g., sensed by the sensor(s) 240). For instance, the sensor(s) 240 may track or gather data related to behavior or activity within a sensor range of the backsplash 200a. In some implementations, interactions of the user 70 (e.g., touch, gesture, or other interactions with the backsplash 200a) may be monitored (e.g., along with sensor data) to understand a user's preferences or associated information with a user's profile. For example, the user profile may be monitored by the backsplash 200a for location movement patterns of the user 70, locations visited by the user 70, digital media content consumed by the user 70, purchases made by the user 70, or updates to various settings in the user profile. In some implementations, the user profile is associated with other user identities, such as identities of the user 70 on applications (e.g., social media, media content accounts, etc.) or other devices 30, 40. For instance, when a user identity is associated with a user profile for the backsplash 200a, the backsplash 200a may monitor and identify changes or user behaviors with respect to such an identity. In other words, the backsplash 200a may identify social media usage or physical activity sensed by a wearable device. With this various information, the backsplash 200a may update settings or characteristics of a user profile associated with a user 70 (e.g., based on permissions configured by the user 70 of the user profile). The displayed content may be updated to respond to changes sensed in the user's behavior or patterns, such as displaying content that suggests healthy eating recipes in response to increased sensed frequency of low nutrition food or snacks or suggesting to start a coffee maker when the user is determined to likely be tired.

In some examples, the user profile generates or includes images or media content in the display 230 (e.g., default content or customized content). For instance, the user profile is a preselected layout and/or contents of a control interface. In some examples, the contents of a control interface displayed on the display 230 of the backsplash 200a may correspond to accessible user settings.

In addition to providing interactively displayed content (e.g., images) in response to the inputs and presence of a user 70 or sensed activity near the display 230, the backsplash 200a may be used for additional functions. For instance, the display 230 may have a decorative function, such as to display static or dynamic wallpaper or background images, such as a backsplash tile pattern, a color or design desirable to correspond with the surrounding decor, a desirable picture or video, such as an outdoor environment simulation or other entertainment media, among other conceivable display imagery. The static or dynamic wallpaper or background image may be displayed at a lower or alternative light intensity to mimic the appearance and visible texture of a traditional tile backsplash surface.

Moreover, one or more portions of the display 230, such as along an upper edge of the display 230, may be used for providing lighting under a cabinet 108 and onto the work surface of the countertop 106. A bar across the top of the display 230, for example, may be white light or adjustable for any color the user would like while intensity can be the size of the box to provide additional light in an area. Such a lighting function of the display 230 can also be used in conjunction with the sensors 240, such as to provide a light that tracks the user 70 at night or when configured.

Generally speaking, the backsplash 200a may be configured for several different input mechanisms, such as a visual input (e.g., gesture or position) or an audio input (e.g., voice). For instance, a sensor signal from a sensor 240 may indicate the presence of a triggering event to operate the functionality of the backsplash 200a. The triggering event may be a user's location being within a threshold distance from the backsplash 200a or may be identifying a characteristic of the user 70 based on the received sensor signal. When a triggering event occurs, hardware (e.g., computing device 250) within the backsplash 200a may transmit an initiation communication to the backsplash 200a. This initiation communication may instruct the backsplash 200a to display or alter an image at a section S of the display 230 (e.g., a portion of a screen 232 associated with the display 230). For example, the backsplash 200a generates an image near the identified location of the user 70 or generates a preselected setting associated with the identified user 70. As additional users 70 are present and identified in the sensor(s) 240, the backsplash 200a may similarly react by displaying images near or in a useful position to the additional identified user 70. For instance, FIG. 2D illustrates the first and second section S₁, S₂ where content may be displayed on the backsplash 200a. Here, a first user 70 may display content on the first section S₁ of the backsplash 200a, while a second user 70 displays content on the second section S₂ of the backsplash 200a.

Referring further to FIG. 2B, the backsplash 200a may also include its own computing capabilities such that the backsplash 200a includes a computing device 250 with local resources 252, such as data processing hardware 254 and memory hardware 256. Here, the sensor 240 communicates sensor data 242 to the computing device 250 for it to be stored (e.g., in the memory hardware 256) or to perform operations (e.g., using the data processing hardware 254). The computing device 250 therefore may perform sensor processing to translate sensor data 242 to provide inputs or feedback to the various functionality of the backsplash 200a. For instance, image processing by the computing device 250 generates proximity and location information for objects (e.g., users 70, appliances 110, gadgets, utensils, food, etc.) within the sensing field of the sensors 240. In some examples, the computing device 250 executes an OS that generates content shown on the display 230 (e.g., based on sensing a user 70 or activities of a user 70 near the backsplash 200a). With an OS, the backsplash 200a may display applications (e.g., word processors applications, spreadsheet applications, accounting applications, web browser applications, email clients, media player, file viewers, etc.) as interactive window(s) 260 on the display 230 for a user 70. In some examples, the backsplash 200a is configured to alter applications (e.g., configurations related to applications) of the computing device 250. For instance, the backsplash 200a may add, remove, or modify applications based on interactions of a user 70 with the backsplash 200a. An example of this would be that the backsplash 200a recognizes that a particular application is never or rarely used by users 70 of the backsplash 200a. Here, the backsplash 200a may reduce clutter in the interface or computing resources of the computing device 250 by, for example, removing (or hiding) the application.

In some configurations, the computing device 250 manages a kitchen API 258 for the backsplash 200a. With the kitchen API 258, other devices 40 in, or not in, the home 10 may integrate with the backsplash 200a. For example, the backsplash 200a is a middleware device that operates as a central hub for appliances 110 of the kitchen 100 while also communicating with other devices 30, 40, 50. For example, the backsplash 200a communicates with a smart hub for the home environment 10. In other words, a user 70 may use the backsplash 200a to turn on smart lights throughout the home 10 or to enable/disable parental controls at a smart television for younger children while in the kitchen 100 cooking. Appliance makers may allow the backsplash 200a to manage and/or to control appliances 110 because a user 70 generally has to be present to interact with the backsplash 200a. With this approach, the backsplash 200a may alleviate safety concerns for appliance makers because the functionality of the backsplash 200a may be conditioned upon the presence of the user 70 within the kitchen 100 (e.g., recognizable by the sensor(s) 240). In other words, appliance control may be contingent upon sensor detection at the backsplash 200a. More particularly, in some implementations, the backsplash 200a receives sensor data 242 from the sensor 240 (e.g., at the computing device 250). The backsplash 200a determines that the sensor data 242 indicates the presence of the user 70 and activates the kitchen API 258 based on the presence of the user 70. Here, with activation of the kitchen API 258, the backsplash 200a displays a window (e.g., an interactive window) of the kitchen API 258 on the display 230.

In some examples, the kitchen API 258 is programmed to perform various functionality. For example, the kitchen API 258 is programmed to parse text displayed on the display 230. Here, by parsing or interpreting text, the kitchen API 258 may generate content windows or interactive content (e.g., touch switches or an interactive control panel for appliances 110). In some implementations, when the user 70 displays a recipe, the kitchen API 258 parses the text to generate video content (e.g., to teach a food preparation technique or cooking technique) or to activate/deactivate appliances 110 within the kitchen 100. For instance, the kitchen API 258 preheats the oven to a defined temperature from the text or starts a timer for the user 70 from a defined time from the text. In other words, the kitchen API 258 may generate tasks for appliances 110 and/or devices 30, 40, 50 that are connected to the kitchen API 258 (e.g., based on content generated at the display 230).

With the capabilities of the sensor 240, the backsplash 200a is configured to understand a person, such as the user 70, within the kitchen 100. For instance, the backsplash 200a estimates movements (e.g., gestures of the user 70), estimates poses (e.g., orientations of the user 70), performs facial recognition (e.g., to identify the user 70), or performs gaze recognition (e.g., to identify a viewing direction of the user 70). Additionally or alternatively, the backsplash 200a uses the sensor 240 to understand objects other than a person or interactions of a person with other objects. For example, the backsplash 200a uses the sensor 240 to recognize opening or closing an appliance 110 or a cabinet 108. In other examples, the backsplash 200a recognizes objects such as a knife that the user 70 is using to chop food or, more generally a food object a user 70 is interacting with in the kitchen 100.

In some examples, the backsplash 200a recognizes motion of an object such as the user 70. Initially, when a user 70 enters the kitchen 100, the sensor(s) 240 of the backsplash 200a generate sensor data 242 indicating the presence of the user 70. In some examples, the backsplash 200a uses the sensor data 242 to perform facial recognition. For facial recognition, the backsplash 200a may be preprogrammed with a facial profile of the user 70 (e.g., have a facial recognition initialization process that generates a facial profile for the user 70) or learn a facial profile for the user 70 overtime with the collection of sensor data 242 for the user 70. In either case, the backsplash 200a (e.g., via the kitchen API 258) may prompt the user 70 to generate or to accept a facial profile. In some examples, the backsplash 200a has a setup process to initiate the backsplash 200a to the environment of the kitchen 100 and/or the user 70. In these examples, the setup process may identify a location of the user 70 and/or initial preferences of the user 70.

In some configurations, a facial profile has preferences or control rights at the kitchen API 258. For example, the sensor 240 of the backsplash 200a serves as an authentication mechanism for the user 70 to verify that he or she is authorized with control rights at the kitchen API 258. This feature may allow a first user 70 (e.g., a parent) to use the kitchen API 258 without takeover from a second user 70 (e.g., a child) that is unauthorized to use the kitchen API 258 or some functionality of the kitchen API 258. In some examples, different users 70 have different levels of control rights related to appliances 110 and/or to features of the kitchen API 258.

In some implementations, the backsplash 200a generates one or more windows 260, 260a-n within the display 230 (e.g., by the computing device 250 or through the kitchen API 258) that are interactive with the user 70 (e.g., as shown in FIGS. 2E, 4A, and 4B). Here, a window 260 may refer to an area of content, such as text, multimedia (e.g., images or video), or any combination thereof In some examples, a window 260 is interactive by enlarging or reducing the window 260 in size depending on a position of the user 70. For instance, the backsplash 200a determines the user's depth d from the backsplash 200a and scales the size of content within the window 260 or the window 260 itself based on the user's depth d (e.g., proportionally with the user's depth). In some examples, the backsplash 200a determines the user's depth d from a position of the sensor 240 within the kitchen 100 to a position of the user 70 within the kitchen 100 (FIGS. 4C-4E). For instance, the sensor 240 uses TOF sensor data 242 to determine the depth d of the user 70. For scaling purposes, the backsplash 200a may be configured with preprogrammed size-to-depth ratios (i.e., sizes for the content based on depth). In some examples, these ratios may be further customized by the user 70 (e.g., adapted for users with nearsightedness, farsightedness, or other eye conditions such as astigmatism). In yet other examples, the user 70 of the backsplash 200a programs preferences (e.g., in a user profile) such as a content size or default content size at one or more depths from the sensor 240.

As shown in FIG. 2E, the display 230 of the backsplash 200a may include images or media content that provides a control interface for a user 70 of the backsplash 200a. With a control interface, the user 70 may operate the backsplash 200a itself and/or connected devices 30, 40, 110 communicating with the backsplash 200a. In other words, a control interface and/or different types of interactive content at the backsplash 200a allows the user 70 to generate inputs that perform functionality of the backsplash 200a. The backsplash 200a at the display 230 may also provide feedback from connected devices 30, 40, 110, such as by initiating feedback when a user 70 is detected in the kitchen 100 or near the display 230. The feedback from the connected devices 30, 40, 110, for example, may include a coffee maker needing descaling treatment, a dishwasher indicating that the contents are clean and requesting the user to empty the contents, or a refrigerator indicating that the internal water filter needs replacement, among other conceivable connected device indications. Also, in cases where the connected devices 30, 40, 110 are on or near the countertop 106, the feedback may be displayed partially or fully on a section of the display 230 near the connected device 30, 40, 110. For example, a flashing arrow on the display 230 points to a coffee maker in need of cleaning or with coffee brewed and ready for the user 70.

Referring to FIG. 2E, the backsplash 200a may generate a display 230 that includes a control interface 270 with a circular configuration of icons 272, 272a-f (e.g., in one or more windows 260 of the display 230). Here, each icon 272 may be an interactive button that is capable of being selected by the user 70 (e.g., via touch contact at the overlay with touch capabilities) to access the corresponding system or device controls. The icons 272 may be linked to various applications to provide corresponding control interfaces, such as for a phone, recipes, oven control, appliances, home security, weather, settings (for the display), video, among various other conceivable applications. By selecting a button corresponding to an icon 272, such as via pressing against the touchscreen, the control interface may disappear, reposition, or minimize to display the selected content, or may otherwise display in an available area or section S of the display 230.

FIG. 2E is an example of the display 230 with two display windows 260, 260a. Each window 260 has been outlined to indicate where applications of the backsplash 200a may display content. For example, the first window 260a depicts the backsplash 200a displaying a weather forecast while the second window 260b depicts the backsplash 200a displaying an internet browser. The user's identified user profile may also have a desired setting for content to be automatically display in such a display area or prior accessed applications that can be displayed in preconfigured windows 260 or areas of the display 230 without having to navigate the control panel of the control interface 270. There are various conceivable arrangements, layouts, and settings of displayed content and user interface controls from that shown and described herein that may also be incorporated into other examples of the backsplash 200a. For instance, the backsplash 200a may incorporate user-defined skins or backgrounds or the incorporation of mirroring a control interface of another user device 30, 40 (e.g., mobile device) or other preferred control layout.

In some configurations, the backsplash 200a is configured to display media or graphical content such as the icons 272 and/or the windows 260 at a location unobstructed from objects adjacent to the backsplash 200a. In other words, the backsplash 200a tries to avoid displaying content behind an object that would obstruct the line of sight to the user 70. For example, the display content may move when a countertop appliance 110 or object is present on counter 106, such as a toaster, stand mixer, bag of groceries, or the like, that is placed generally in the user's line of sight of the originally displayed content. The backsplash 200a may use sensor data from one or more sensors 240 to locate an obstructing object, and based on the sensor data, the backsplash 200a (e.g., via the computing resources associated with the backsplash 200a) may monitor the location of the detected objects relative to the location of the user 70 or content generated on the display 230 to determine the user's general line of sight and prevent content from being displayed behind the detected object or objects in the determined line of sight.

Furthermore, the sensor 240 (or a neural network of sensors 240) may identify a type of object (e.g., the obstructing object) within the field of view of the sensor 240. With the identification of the object, the backsplash 200a may use the identification to log or to record the object. In some examples, the sensor data of the sensor 240 may be used to recognize, monitor, and inventory the types of food that are placed on a countertop 106 near the backsplash 200a. The sensor data may also be used to monitor the use of recognized food. For instance, the backsplash 200a is configured to recognize, based on sensor data processing, when a user 70 consumes, disposes, or stores the identifiable food item (e.g., a food item programmed or learned to be identified using data processing). This would allow the backsplash 200a or other storage devices communicating with the backsplash 200a to maintain an inventory listing of food, such as fresh fruits and vegetables. For example, an inventory application of the backsplash 200a logs time data (e.g., inventor dates) and/or sensor data relating to its inventory that has been sensed by the backsplash 200a. The backsplash 200a (e.g., via its application(s)) may remind the user 70 of inventory states of the food, such as when food is approaching or beyond an estimated expiration date. For instance, the backsplash 200a may sense the number of apples and bananas in a fruit storage basket on the countertop 106 and notify the user 70 when the apples or bananas are low, gone, or show evidence of spoliation. This functionality may be advantageous to the user 70 to help the user 70 to reduce food waste, recommend recipes that incorporate the food on hand, and maintain the user's desired diet.

Referring now to FIG. 2F, an example of the backsplash 200a with various optional inputs and supportive operational systems. For example, the sensor 240 is shown as a camera with a sensor field capturing three users 70, 70a-c, each with a unique user ID. The sensor 240 is in communication with a local identification and location system 280, whereby a controller (e.g., the computing device 250) may identify the user 70 (corresponding to a user profile or ID) and locate the user 70 relative to the display 230. Similarly, as noted above with reference to the use of a wireless receiver as the sensor 240, the local identification and location system 280 may be in communication with a device 30, 40 (e.g., a mobile device) to assist with user identification and location. Also, the system shown in FIG. 2F shows integration with both remote resources 52 and local resources (e.g., of the computing device 250), such as local media, cameras, graphic backdrops, and interface protocols communicating with the display 230. Here, a converter 282 may receive multiple video inputs that may be scaled and/or parsed into a video output 284. The remote resources 52, such as video media, cameras, and interface protocol, may also communicate with the backsplash 200a through the controller having the control overlays and workspace control and configuration features.

As shown in FIG. 2G, another example of a backsplash 200a is shown with various optional inputs and supportive operational systems that incorporate cloud computing, which is generally referenced by at least some use of a network of remote servers hosted on the Internet to store, manage, and process data, rather than a local server or a personal computer. In the example shown in FIG. 2G, both remote resources 52 and local resources 252 may be utilized via the cloud (i.e., remote computing devices 50), which may include functionality to act as the converter 282. The cloud converter 282 may receive image data desired to be displayed, such as multiple video inputs, and may scale and/or parse that image data into video output 284, such as in whole or in part with cloud computing resources 52.

With reference to FIG. 2H, a further example of a backsplash 200a is shown with various optional inputs and supportive operational systems. In this example, workspace processors 252, 252a-d that control the display 230 and touchscreen 234 are connected to a router 30, which communicates with the remote computing 50 (e.g., cloud computing) to provide more use and integration of cloud computing. Again, both remote resources 52 and local resources 252 are utilized via the cloud 50, which provide image conversions, scaling, parsing, among other conceivable processing and data storage capabilities. It is contemplated that in addition to the exemplary backsplashes 200 provided herein that the background infrastructure of other examples of a backsplash 200a may be configured in various other manners, such as to provide more or less cloud computing integration with the hardware 254 installed at the backsplash 200a.

As shown in FIG. 21, an example of the backsplash 200a is shown with the display 230 having a single touchscreen (e.g., overlay 234) overlaid on a plurality of screens 232, 232a-d, where an interactive display area of the display 230 is disposed at the overlapping areas of the touchscreen 234 and the screens 232. The screens 232 are each connected to a workspace controller 252, which are connected to a hub computer (e.g., the computing device 250). The hub computer 250 may operate to determine the user 70, to store and display content and the interactive display area, and to control interaction with the interactive display are. The hub computer 250, as shown in FIG. 21, may access the cloud 50 to operate multiple inputs to independent video and to an output converter, among other conceivable cloud computing integration.

With respect to an example of user identification and locational interaction with an interactive display system, FIG. 2J shows an initial determination step 286 that determines whether a user 70 is identified. When the user 70 is identified, a user profile of controls can be loaded or accessed at the display 230 of the backsplash 200a. If a sensed user 70 has not yet been identified, the exemplary process determines whether a facial identification can be made, such as with image processing of image data captured by a sensor 240 connected to the backsplash 200a. Once a first identification is made, such as via facial recognition at step 288, a secondary identification step 290 may be used to further ensure the user identification is accurate, such as via phone identification from a wireless router (e.g., a network device 30). Other secondary identifications may be used, such as with passwords or other biometric sensed data, to provide the desired user identify confidence and well as the desired ease of access and security level to the user profile.

As also shown in FIG. 2J, once a user 70 is identified, such as at steps 288 and 290, the system may monitor for an interaction (e.g., touch interaction) with the backsplash 200a at step 292. An interaction event (e.g., shown as a touch event) received at step 292 may then evaluate to see if the user 70 has changed location at step 294. An identified movement of the user relative to the display 230 may process a sub-process 296 that includes series of steps to determine whether and how the displayed content should be reconfigured at the display 230. It is conceivable that various alternative processes may be used by the backsplash 200a to determine and monitor the user identification and location.

Optionally, a controller (e.g., the computing device 250) of the backsplash 200a may locate a secondary user 70 at or near the interactive display area of the display 230, while the initial user 70 is still located at or near the interactive display area. The controller may also identify a characteristic of the secondary user 70 based on the sensor signal, such as to also access a user profile for the secondary user 70. The controller may simultaneously interact with the secondary user in substantially the same manner as the other user operating the backsplash 200a, except the interaction may be located on the display in a location convenient to the user 70 and customized with available preferences and settings for the identified secondary user 70. The system may be programed to give certain priority to the first or second user 70 of the backsplash 200a, such as to prevent repositioning the control panel and content displayed specifically to the prioritized user 70. The system may also operate further with more users 70 as the backsplash 200a and environment can accommodate.

FIG. 2K is an example of a calibration routine for the backsplash 200a. The calibration routine may be used to determine a virtual boundary of the interactive display area of the display 230 where the virtual boundary defines a border of an accessible portion of the interactive display area. The calibration routine also aligns the touch coordinates of the touchscreen 234 to the pixel display coordinates of the one or more screens 232 of the display 230. The calibration routine may prompt a user 70 to provide an input (e.g., touch event) at an accessible location (e.g., a corner C) of the interactive display area. As shown in 2K, the accessible corners C, C₁ (e.g., corners C_{1a-d}) may correspond with the outer corners of the one or more screens 232 forming the display 230; although in configurations where the display 230 extends beyond the touch panel (such as when a portion of a display 230 is hidden behind an appliance 110 or in a channel of a support base), the accessible corners C₁ of the interactive display area may not correspond with the outer corners of the display 230. The system may also request that the corners C, C₂ of the in individual screens 232 (e.g., corners C₂ₐ₋₁) forming the display 230 be identified, such that each screen 232 is individually calibrated with the overlaying touchscreen 234. Once the user provides touch events at the accessible corners C₁ and the corners C₂ of the individual screens 232, the touch events may be used as edge definition markers of the virtual boundary. The calibrated virtual boundary may be stored locally and/or remotely for the backsplash 200a to access for all future use.

Referring to FIGS. 3A-3C, the functionality of the backsplash 200a as an interactive display 200 may translate to display structures outside the kitchen environment. For example, when the user 70 leaves the backsplash 200a operated in a residential kitchen setting (e.g., as shown in FIG. 1C), the user 70 may later access content on another display system or device, such as on a mobile device; on a display assembly 200, 200b in a work environment (FIG. 3A), such as an office setting or medical patient room; on a display assembly 200, 200c in a motor vehicle (FIG. 3B), such as a ride-share vehicle; or on a display assembly 200, 200d in a mass transit vehicle, such as an airplane (FIG. 3C), among other conceivable alternative devices or environments for accessing another display system. In each of these devices or additional display systems 200, the user profile may be accessed and updated to allow the user 70 to seamlessly interact and/or operate the applications accessed and content displayed at the previously accessed display system. Accordingly, the user profile along with associated user settings may be stored in remote resources 52 such that the user profile may be accessed using these other display assemblies 200a-d. As the user profile of a user 70 is accessed and used by a display system 200, the system 200 may store or update the user's settings, activity, or recently accessed applications and corresponding usage. By storing settings and configurations for one or more users 70, display systems 200 may remove the user's displayed content when a user 70 leaves a sensor field associated with a respective display system 200 and subsequently generate the user's displayed content when the user 70 returns to any environment with a compatible display system 200 (e.g., a display system 200 communicating with remote resources storing and maintaining a user profile). This approach allows various display systems 200 to seamlessly resume activity and interaction configurations of the user 70. This user profile of the display system 200 may also be accessed by other display systems 200 (e.g., systems 200a-c) or devices 30, 40 to also allow the user 70 to continue to operate features (e.g., applications) and/or content displayed at the display 230.

Referring to FIG. 4A, in some examples, sensor data 242 from the sensor 240 indicates a motion gesture 72 by the user 70. Here, the backsplash 200a may have already recognized the user 70. In some examples, with recognition of the user 70 initially, the backsplash 200a determines that current sensor data 242 indicates a change in a pose P of the user 70 from the initial pose P of the user 70. A pose P refers to an orientation of the user 70 and may include the orientation of a user's limbs and head in addition to the user's body. When the backsplash 200a determines that the user 70 has changed poses P, the backsplash 200a further determines whether the change in poses P corresponds to a motion gesture 72. For instance, the backsplash 200a may be configured with a particular set of motion gestures that trigger a display response at the display 230. In some examples, when the backsplash 200a determines that the user 70 performs a motion gesture 72, the backsplash 200a generates an associated movement for an interactive window 260 based on the motion gesture 72. In some implementations, when the backsplash 200a determines based on sensor data 242 that the motion gesture 72 by the user 70 is a hand swipe, the backsplash 200a moves an interactive window 260 from a first position to a second position in the direction of the hand swipe. In other words, the interactive window 260 may move from a center position aligned with the user 70 to an offset position misaligned with the user 70 (e.g., in the direction of hand swipe). Other examples of motion gestures 72 include push or pull (e.g., an open palm to a fist) motions by the user 70 that push the content window 260 from the foreground to the background of the display 230 or pull a content window 260 from the background into the foreground of the display 230. In some examples, a user 70 aligns his or her palm over a content window 260 and closes his or her palm to a fist (i.e., grasps the content window 260) to move the window 260 about the display 230 to a final position where the user 70 once again opens his or her fist (i.e., releases the window 260).

Unfortunately, the sensitivity of the backsplash 200a may cause the backsplash 200a to move displayed content even though the user 70 does not intend to move or interact with the displayed content. For example, FIG. 4B depicts the head of the user 70 moving due to sway of the user 70 between three poses P1-3 even though the body of the user 70 is predominantly not moving. In this scenario, the backsplash 200a may move the displayed content back and forth with the sway of the head potentially causing visibility issues for the user 70. To overcome this issue, the backsplash 200a may use a few different approaches. In a first approach, the backsplash 200a transitions to a stabilization mode where once the backsplash 200a initially recognizes a user 70 (e.g., or senses a user 70 in the kitchen 100 in front of the backsplash 200a), the backsplash 200a changes from a level of high sensitivity that detects minor movement or deviation in a pose P of the user 70 to a lower level of sensitivity. Here, the lower level of sensitivity may include a movement threshold where the backsplash 200a first determines whether a difference between a first position (e.g., a first pose P1) of the user 70 in a first instance of time and a second position (e.g., a second pose P2) of the user 70 in a second instance of time satisfies the movement threshold (e.g., exceeds the movement threshold). When the difference satisfies the movement threshold, the backsplash 200a then allows the interactive window 260 to move with the user 70 (or move in response to a positional change between instances). For example, the backsplash 200a (i) generates a wireframe outline of the user 70 at the first instance in time and at the second instance in time and (ii) determines whether deviation in positions at some number of points (e.g., a predetermined number of points) along the wireframe satisfies the movement threshold.

In another example, the backsplash 200a generates a grid for the field of view FV and changes the size of cells (e.g., pixels) within the grid to correspond to the level of sensitivity (e.g., resolution of sensitivity). With the grid adjusted for the sensitivity level, the backsplash 200a may then determine whether a user's movement according to the grid should result in movement of the interactive window 260. Here, the backsplash 200a may also utilize the movement threshold when evaluating the user's movement according to the grid. Otherwise, the backsplash 200a may simply determine whether a new position of the user 70 results in cell changes in the grid and move the interactive window 260 when a majority of cells change.

In some configurations, the sensor data 242 allows the backsplash 200a to determine joints of the user 70. With joint information, the backsplash 200a may distinguish between areas of the user's body that correspond to a limb or a head. In another approach, once the backsplash 200a initially recognizes a user 70 (e.g., or senses a user 70 in the kitchen 100 in front of the backsplash 200a), the stabilization mode isolates movement recognition by ignoring movement from the head and/or the limbs of the user 70. For example, in this approach, instead of the backsplash 200a tracking movement of the user 70 by the head of the user 70, the backsplash 200a tracks the user 70 by a perceived center of mass (i.e., a center of mass of the non-ignored body of the user 70). By tracking the user 70 by the perceived center of mass, the interactive window 260 may still normally move with the user's perceived center of mass without resulting in a significant amount of jitter (i.e., back and forth movement).

In some examples, the ability to move a window 260 to track movement of the user 70 may be enabled or disabled (e.g., externally by the user or internally by the backsplash 200a). For example, the user 70 may provide a verbal command, such as “follow me”, to enable movement of a window 260 displayed. When the ability to move a window 260 is enabled, the backsplash 200a may use the stabilization modes discussed previously.

Referring further to FIGS. 4C-4E, the backsplash 200a is configured to enable a window 260 to track the user 70. In other words, the window 260 may follow the user 70 within an area corresponding to the backsplash 200a as the user 70 moves about the kitchen 100. For example, FIGS. 4C-4E show a sequence of the user 70 moving from behind a kitchen island 106, 108 to the refrigerator 110a to the sink 110e. During this sequence, the position of the window 260 tracking the user 70 is shown in as an “X” at a particular location L. In these examples, the backsplash 200a extends along adjacent walls 102 in a corner of the kitchen 100. In some implementations, the location L of the window 260 accounts for the size (e.g., width) of the backsplash 200a, a location of a sensor 240 providing the sensor data 242 for the backsplash 200a, and/or a yaw rotation of the user 70 (e.g., relative to the sensor 240). The yaw rotation refers to a rotation about an axis extending along a height of the user 70, such as an axis that extends along a generally vertical direction. In FIG. 4C, the user 70 is facing the stove 110d and parallel to the sensor 240 with a depth d and a distance D from the sensor 240. Based on these parameters and the knowledge of the location of each screen 232 (e.g., defining a width of the backsplash 200a), the backsplash 200a determines a first location L, L1 for the window 260 that the backsplash 200a determines is optimal for viewing the window 260 (e.g., a location at a shortest distance from the user 70 according to the user's yaw rotation). In FIG. 4D, when the user 70 moves to the refrigerator 110a, the user 70 has a depth d equal to a distance D. Based on these parameters and the knowledge that the backsplash 200a does not extend all the way to the refrigerator 110a (e.g., terminates at the dishwasher 110b), the backsplash 200a may also account for the yaw rotation of the user's head with respect to the sensor 240 to accommodate for a gaze of the user 70. With this additional parameter corresponding to the yaw rotation of the user's head, the backsplash 200a displays the window 260 at the second location L, L2 near the position of the sensor 240. Applying the same approach, in FIG. 4E, the backsplash 200a displays the window 260 at the third location L, L3 when the user 70 is in front of the sink 110e. Here, the yaw rotation of the user's head is nearly perpendicular to the sensor 240. Therefore, this rotation influences the backsplash 200a to generate the window 260 behind the sink 110e instead of at the location of the sensor 240.

In some examples, the backsplash 200a is configured to provide suggestions to the user 70. These suggestions may be based on previous interactions that the user 70 has with the backsplash 200a or user preferences (e.g., set by the user 70 or learned by the backsplash 200a). In other words, the backsplash 200a may perform and/or prompt actions within the display 230 of the backsplash 200a or elsewhere in the kitchen 100 (e.g., based on a user's history of interaction with the backsplash 200a). For example, the backsplash 200a makes suggestions to the user 70 based on patterns of behavior. To illustrate, the user 70 may often use the backsplash 200a in a routine fashion. For example, the user 70 often engages the backsplash 200a to display cooking technique videos when displaying a cooking recipe. Here, the backsplash 200a, therefore suggests or prompts the user 70 to initiate cooking technique videos relevant to a recipe when the user 70 choses to display the recipe. Additionally or alternatively, the backsplash 200a uses the user preferences or information that the backsplash 200a learns about the demographic of the user 70 to generate content for the user 70. For instance, the backsplash 200a generates particular advertisements, media content (e.g., music or videos), or recipes based on the demographic of the user 70. Here, the backsplash 200a may use a pooled demographic model to generate content suggestions for the user 70.

In some implementations, the backsplash 200a learns that the user 70 enjoys particular applications when the user 70 performs different tasks in the kitchen 100. In other words, the backsplash 200a makes associations with a user's input to the backsplash 200a and the output (e.g., display or computing execution) by the backsplash 200a in response to the user input. Here, the user input may be an active input (i.e., an intentional input where the user 70 interacts with the backsplash 200a) or a passive input (i.e., user actions in the kitchen 100 sensed by the backsplash 200a). In some examples, the backsplash 200a forms at least one data log or data set of these types of associations (e.g., for machine learning). For example, when the user 70 cooks in the kitchen 100, the user 70 generally listens to music through, for example, a media application that plays music. In this example, when the backsplash 200a recognizes that the user 70 is cooking, the backsplash 200a may display a prompt suggesting that the user 70 wants to sign-in/use the media application. Here, the media application may be an application of the computing device 250 of the backsplash 200a or a media application of another device in communication with the backsplash 200a. In some examples, the backsplash 200a is configured with permissions to automatically sign-in to a particular application for a user 70. In some configurations, the backsplash 200a may even suggest actions within a particular application. For example, if the user 70 is an avid jazz listener or listens to a particular program at certain times (e.g., listens to the 6:00 p.m. local news), the backsplash 200a may not only sign into an application that is capable of providing that experience, but also initiate that experience within the application. In other words, the backsplash 200a starts up jazz music or launches a feed of the 6:00 p.m. local news. In some examples, the backsplash 200a is configured to sign into various applications based on user recognition (e.g., facial recognition of the user 70). In other words, a first user 70 may have a multimedia profile with an application which a second user 70 has a different multimedia profile with the same application (or a different application). Here, when the backsplash 200a recognizes the first user 70, the backsplash 200a may be configured to launch and/or sign into an application profile associated with the first user 70.

In some implementations, the backsplash 200a performs predictive actions based on perceived user behavior. For instance, the backsplash 200a recognizes that the user 70 has his/her hands full with a cookie sheet moving towards the oven and the backsplash 200a communicates with the oven to open the door of the oven. In other examples, the backsplash 200a predicts content that the user 70 may want to display on the backsplash 200a based on other actions of the user 70. For example, when the user 70 displays a recipe on the backsplash 200a and moves towards the refrigerator, the backsplash 200a may display items that may be found in the refrigerator on the display 230 of the backsplash 200a or a display screen of the refrigerator.

In some configurations, the backsplash 200a performs sentiment analysis of the user 70 when the user 70 is in sensor range of the backsplash 200a. Here, sentiment analysis refers to using sensor data 242 from the sensor 240 to determine a mood of the user 70. In some examples, the backsplash 200a is configured to perform sentiment analysis by facial expressions of the user 70. For instance, beyond facial recognition, the backsplash 200a analyzes sensor data 242 corresponding to the face of the user 70 to identify facial expressions. In some examples, the backsplash 200a is preconfigured with a database of facial markers that are associated with various moods. In other examples, the backsplash 200a is configured to infer moods of the user 70 based on actions of the user 70. For instance, the user 70 plays slow music or music that is known to be depressing. Additionally or alternatively, the backsplash 200a uses sensor data 242 to analyze the body posture of the user 70. In other words, body posture may be another sign of a person's mood. For instance, when a person is sad or depressed, the person may have a slumped body posture with his or her shoulders rolled forward at a lower height than when the user 70 is fully erect. Another example is that when a user 70 is happy or excited his or her shoulders may be lifted to a position where the user 70 is fully erect (e.g., a user exudes confidence when happy and naturally puffs out his or her chest towards a fully erect posture).

In some implementations, the backsplash 200a attempts to change a mood of the user 70 based on the content that the backsplash 200a provides to the user 70. For example, when the user 70 appears to be sad or depressed, the backsplash 200a may display content that is funny or uplifting. To illustrate, the backsplash 200a may audibly tell a joke to the user 70 or play a video known to have comedic value. In some examples, the backsplash 200a changes a background of the display 230 based on the sentiment analysis. For instance, if the user 70 appears to be sad, the backsplash 200a changes the background from a neutral display (e.g., a single basic color) to an escapist background (e.g., a beach background or a beautiful landscape). In another example, the backsplash 200a shows images (e.g., like a slide-show) that the user owns (e.g., has stored in a storage space accessible to the backsplash 200a) since images often depict still frames of memorable moments.

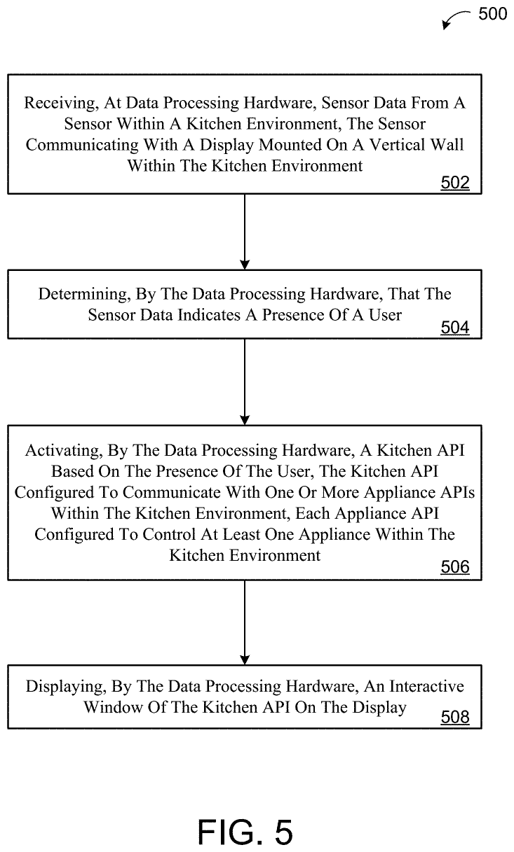

FIG. 5 is an example of a method 500 of operating the backsplash 200a. At operation 502, the method 500 receives sensor data 242 from a sensor 240 within a kitchen environment 100 where the sensor 240 communicates with a display 230 mounted on a vertical wall 102 within the kitchen environment 100. At operation 504, the method 500 determines that the sensor data 242 indicates a presence of a user 70. At operation 506, the method 500 activates a kitchen API 258 based on the presence of the user 70. Here, the kitchen API 258 is configured to communicate with one or more appliance APIs 112 within the kitchen environment 100 where each appliance API 112 is configured to control at least one appliance 110 within the kitchen environment 100. At operation 506, the method 500 displays an interactive window 260 of the kitchen API 258 on the display 230.

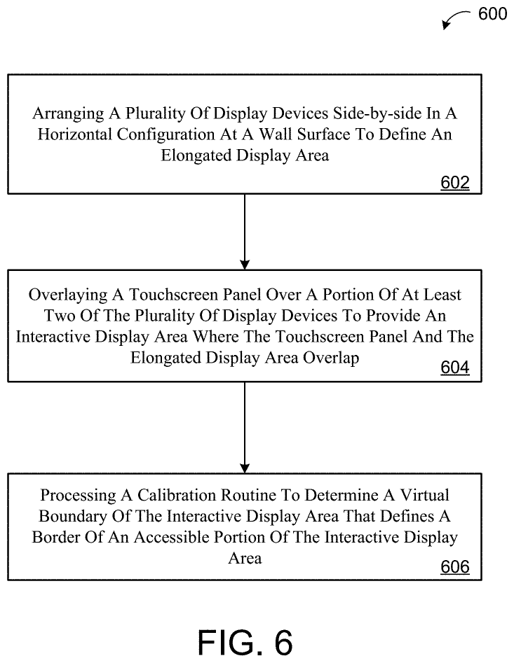

FIG. 6 is an example method 600 of operations to install an interactive display 200. At operation 602, the method 600 arranges a plurality of display devices 232, 230 side-by-side in a horizontal configuration at a surface of a wall 102 to define an elongated display area. At operation 604, the method 600 overlays a touchscreen panel 234 over a portion of at least two of the plurality of display devices 232, 230 to provide an interactive display area where the touchscreen panel 234 and the elongated display area overlap. At operation 606, the method 600 processes a calibration routine to determine a virtual boundary of the interactive display area that defines a border of an accessible portion of the interactive display area.

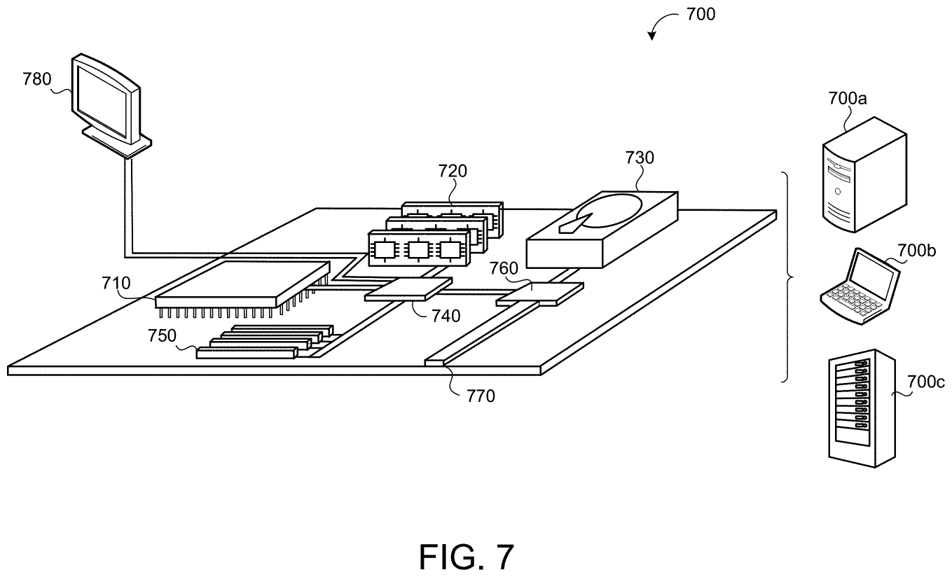

FIG. 7 is schematic view of an example computing device 700 that may be used to implement the systems (e.g., the interactive display 200) and methods (e.g., the methods 400, 500) described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710 (e.g., data processing hardware), memory 720 (e.g., memory hardware), a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure (e.g., the backsplash 200a) can be implemented on a computer (e.g., computing device 250) having a display device (e.g., display 230) for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device (e.g., devices 30, 40, 50) that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A system comprising:
an elongated display having a touchscreen that provides a multi-user interactive display area that is accessible simultaneously by at least two users;
a sensor having a sensor field configured to capture users at or near the interactive display area of the touchscreen; and
a controller configured to:
receive a sensor signal from the sensor monitoring of the sensor field;
determine a location of a first user relative to the elongated display based on the received sensor signal;
identify a characteristic of the first user based on the received sensor signal, wherein the characteristic corresponds with a user profile; and
transmit an initiation communication to the elongated display to display a first image at a section of the interactive display area near the location of the first user, wherein the first image corresponds with a preselected setting of the user profile.

2. The system of claim 1, wherein the controller is further configured to:
receive a gesture communication from the touchscreen in response to a gesture by the first user at the interactive display area; and
transmit a responsive communication to the elongated display to display a second image that confirms the gesture provided by the first user.

3. The system of claim 1, wherein the controller is further configured to:
determine a second location of a second user at or near the interactive display area, while the first user is also located at or near the interactive display area; and
identify a characteristic of the second user based on the sensor signal.

4. The system of claim 3, wherein the controller is further configured to transmit an initiation communication to the elongated display to display a second image at a second section of the interactive display area near the location of the second user.

5. The system of claim 1, wherein the elongated display is configured to be disposed at a wall, and wherein the elongated display comprises a plurality of sections disposed horizontally along the multi-user interactive display area.

6. The system of claim 1, wherein the first image includes a control interface.

7. The system of claim 1, wherein the sensor is configured to capture an object obstructing the interactive display area, and wherein the controller is configured to identify the object based on the sensor signal and display a control interface at a section of the elongated display that does not interfere with the identified object.

8. The system of claim 1, wherein the elongated display comprises a plurality of display devices arranged side-by-side and a capacitive touch screen disposed over at least a portion of the plurality of display devices to define the interactive display area.

9. The system of claim 1, wherein the sensor comprises at least one of a camera, a thermal imager, a microphone, an occupancy sensor, or a wireless receiver.

10. The system of claim 1, wherein the preselected setting of the user profile includes an arrangement of a control interface configured to operate at least one of an oven, a refrigerator, or a thermostat.

11. An interactive display assembly comprising:
a plurality of display devices arranged side-by-side in a horizontal configuration to define an elongated continuous display area that is configured to be disposed at a wall surface;
a touchscreen overlaying at least a portion of the elongated continuous display area to define an interactive display area; and
a controller configured to:
receive a first communication from the touchscreen in response to a touch event at the interactive display area on the touchscreen; and
transmit a second communication to at least one of the plurality of display devices to display an image at an underlying location of the touch event.

12. The interactive display assembly of claim 11, wherein the plurality of display devices comprises at least two LED display panels.

13. The interactive display assembly of claim 11, wherein the touchscreen is disposed over at least two display panels of the plurality of display devices.

14. The interactive display assembly of claim 11, wherein the touchscreen comprises a capacitive touch panel.

15. The interactive display assembly of claim 11, further comprising a support base attached to an edge of the touchscreen, wherein the touchscreen is configured to pivot about the support base away from the plurality of display devices and the wall surface.

16. The interactive display assembly of claim 15, wherein the support base includes a channel that receives and supports a lower edge portion of the plurality of display devices.

17. The interactive display assembly of claim 16, wherein the lower edge portion of the plurality of display devices that is disposed in the channel is not part of the interactive display area.

18. The interactive display assembly of claim 16, wherein the controller is configured to determine the interactive display area with a calibration routine.

19. The interactive display assembly of claim 15, wherein the support base is configured to be disposed between the wall surface and a countertop of a cabinet, and wherein the support base has a thickness that is substantially equal to a depth of the plurality of display devices.

20. The interactive display assembly of claim 11, further comprising a power strip attached along an upper edge of the touchscreen, wherein the power strip has at least one outlet that is configured to receive an accessory plug.

21. The interactive display assembly of claim 11, further comprising a sensor having a sensor field configured to encompass an area near the touchscreen, wherein the sensor is configured to identify a user near a section of the elongated continuous display area.

22. The interactive display assembly of claim 21, wherein the controller is configured to cause the plurality of display devices to display the image at the section of the elongated continuous display area identified nearest the user, and wherein the image includes a control interface.

23. The interactive display assembly of claim 21, wherein the sensor comprises at least one of a camera, a thermal imager, a microphone, an occupancy sensor, or a wireless receiver.

24. The interactive display assembly of claim 11, wherein the image includes a control interface configured to operate at least one of an oven, a refrigerator, or a thermostat.

25. The interactive display assembly of claim 11, further comprising a light assembly attached along an upper edge of the touchscreen, wherein the light assembly has a light element that is configured to direct light onto a countertop surface.
